(19) United States
(12) Patent Application Publication
(10) Pub. No.: US 2005/0064325 A1
(43) Pub. Date: Mar. 24, 2005

(54) Planographic printing plate precursor

(75) Inventors: Ippei Nakamura, Shizuoka-ken (JP); Kazuo Maemoto, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/937,336

(22) Filed: Sep. 10, 2004

(30) Foreign Application Priority Data
Sep. 12, 2003 (JP) 2003-321022

(51) Int. Cl. G03C 1/76

(52) U.S. Cl. 430/270.1

(57) ABSTRACT

The planographic printing plate precursor of the invention includes a recording layer capable of forming an image upon irradiation with infrared rays, wherein the recording layer comprises (A) an alkali-soluble resin having, in a main chain, a structural unit containing at least one type of bond selected from an amide bond, urea bond, urethane bond and ester bond and having at least one type of acid group selected from a phenolic hydroxyl group, sulfonamide group and active imide group, and (B) an infrared absorbing agent. The invention provides a positive-working planographic printing plate precursor excellent in printing durability and chemical resistance.

### CROSS-REFERENCE TO RELATED APPLICATION

This application claims priority under 35 USC 119 from Japanese patent document, No. 2003-321022, the disclosure of which is incorporated by reference herein.

### BACKGROUND OF THE INVENTION

1. Field of the Invention

The present invention relates to a planographic printing plate precursor, and in particular to a positive-type planographic printing plate precursor capable of direct plate-making from digital signals in computers etc.

2. Description of the Related Art

Development of lasers has been remarkable in recent years. In particular, solid lasers and semiconductor lasers which have a high power output but are small in size, and with an emission range in the near infrared to infrared range, have become readily available. In the field of planographic printing, these lasers are extremely useful as sources of light at a time of direct plate-making from digital data in computers etc.

The positive-type planographic printing plate precursor for infrared lasers essentially includes an alkali-soluble binder resin and, an infrared dye which absorbs light to generate heat. The infrared dye, in a region unexposed by light (i.e., an image region), functions as a development inhibitor substantially reducing the solubility of the binder in a developer, by interacting with the binder resin; and, in a region exposed by light (i.e., a non-image region), reduces its interaction with the binder resin due to heat generated by exposure, thus allowing dissolution of the region exposed by light in an alkali developer, to form a planographic printing plate.

The capacity of the positive-type planographic printing plate precursor for infrared lasers to form an image depends on heat generated when the surface of the recording layer is exposed to infrared laser light. Thus in the vicinity of the support, the quantity of heat used in image formation, i.e., for solubilization of the recording layer, is reduced due to diffusion of heat into the support, which results in a lower degree of sensitivity. Accordingly, a problem arises insofar that elimination of the capacity of inhibiting development of the recording layer is inadequate in a non-image region, and thus the difference between an image region and a non-image region diminished, and highlight reproducibility becomes inadequate.

To solve the problem of highlight reproducibility, use of a recording layer is required which is made of a material capable of developing a non-image region easily, that is, by having higher degree of solubility in an aqueous alkali solution.

However, such a recording layer is chemically inferior even in an image region, and has a disadvantage insofar that it is inferior in terms of chemical resistance, and can be easily damaged by an ink washing solvent used in a developer or during printing, or by a plate cleaner etc.

Accordingly, there is a strong demand for a resin material having properties such as excellent coating chemical resistance and durability in a light-unexposed region and which displays superior developability after its capacity to inhibit dissolution has been neutralized by exposure to light.

To solve the problem described above, a planographic printing plate precursor has been disclosed which is provided with a recording layer including a polyvinyl phenol resin-containing lower layer that is excellent in alkali solubility, and an upper layer containing a water-insoluble and alkali-soluble resin and an infrared absorbing agent, the upper layer significantly increasing solubility in an aqueous alkali solution upon exposure to light (see, for example, Japanese Patent Application Laid-Open (JP-A) No. 10-250255). This planographic printing plate precursor exhibits an improvement in sensitivity, but is inadequate in terms of chemical resistance. In this case, other problems arises such as unsatisfactory adhesion of the support to the recording layer and inferior printing durability.

With the same objectives, various improvements to technology have been proposed. Examples thereof include: an image-forming material including a support, a lower layer containing a copolymer having a specific monomer and a photosensitive upper layer, which lower and upper layers are laminated on the support in this order (see, for example, JP-A No. 11-218914); and a method of producing a printing plate using a planographic printing plate precursor made up of an alkali-soluble resin-containing lower layer and an infrared-sensitive and alkali-resistant developable upper layer layered on a hydrophilic support (see, for example, JP-A No. 11-194483).

The former material of JP-A No. 11-218914 is excellent in terms of sensitivity and chemical resistance, but entails a problem insofar that the strength of resin used in the lower layer is inadequate, and there is still room for improvement in terms of printing durability. The latter method of JP-A No. 11-194483 also involves problems insofar that the alkali-soluble resin used is inferior in terms of chemical resistance, and thus a recording layer may be eluted with a solvent component contained in a plate cleaner, or the solvent component may penetrate to the interface between the substrate and the lower layer and reduce the adhesiveness of the recording layer to the substrate, thereby causing the recording layer to peel off easily.

In short, in the aforementioned two references, printing durability, which is dependent on the film strength of the lower layer and chemical resistance can hardly be made compatible with each other.

### SUMMARY OF THE INVENTION

In consideration of the problems in the related art described above, the present invention provides a positive-type planographic printing plate precursor which is excellent in terms of both printing durability and in chemical resistance.

As a result of extensive studies, the inventors have discovered that a positive-type planographic printing precursor as described above can be achieved by using an alkali-soluble resin having a specific structural unit and an acid group as components of the recording layer, thereby duly completing the invention.

In the first aspect of the invention, the planographic printing plate precursor includes a recording layer capable of forming an image upon irradiation with infrared rays, wherein the recording layer includes an alkali-soluble resin (A) having, in a main chain, a structural unit containing at least one type of bond selected from an amide bond, an urea bond, a urethane bond and an ester bond, and having at least one type of acid group selected from a phenolic hydroxyl group, a sulfonamide group and an active imide group (hereinafter, the alkali-soluble resin will be referred to as a “specific alkali-soluble resin”) and an infrared absorbing agent (B). As the type of the bond contained in the structural unit, an amide bond is preferably selected, and as the acid group, a phenolic hydroxyl group is preferably selected.

In the second aspect of the invention, the planographic printing plate precursor has a recording layer consisting of a lower layer containing specific alkali-soluble resin (A) and an upper layer containing an alkali-soluble resin and being capable of forming an image by irradiation with infrared rays, wherein the lower layer and/or the upper layer in the recording layer contains infrared absorbing agent (B). As the alkali-soluble resin contained in the upper layer, novolak resin is preferably used.

The mechanism of the invention is not entirely clears, but is estimated to be as follows.

Specific alkali-soluble resin (A) used in the recording layer of the planographic printing plate precursor of the invention has, in a main chain, a highly aggregated structure selected from an amide bond, an urea bond, an urethane bond and an ester bond. It is believed that for this reason a recording layer excellent in film strength, printing durability, and dissolution resistance to organic solvents etc. is produced.

In a region irradiated with infrared rays (i.e., a non-image region), by the action of an acid group (alkali-soluble group) selected from a phenolic hydroxyl group, a sulfonamide group and an active imide group, excellent dissolution of the resin material is achieved, whereby a high-quality image free of residual film is formed. These acid groups have a high pKa and that they are thus highly lipophilic and excellent in inking property.

In a preferable embodiment of the invention wherein the recording layer has a multi-layered structure (second aspect of the invention), an image region, that is, a region where the upper layer of the recording layer is present as an alkali-resistant development layer, functions effectively because of high degree of film strength and chemical resistance mentioned above and is thus superior in terms of printing durability and chemical resistance. When the upper layer is removed to form a non-image region, it is believed that the lower layer is rapidly dissolved and dispersed in an alkali developer by its inherent alkali solubility.

According to the invention, a positive-type planographic printing plate precursor can be provided which is excellent in terms of printing durability and chemical resistance.

### DETAILED DESCRIPTION OF THE INVENTION

The planographic printing plate precursor of the present invention includes a recording layer capable of forming an image upon irradiation with infrared rays, wherein the recording layer contains specific alkali-soluble resin (A) and infrared absorbing agent (B). For the purpose of enhancing inhibition (capacity to inhibit dissolution) of the recording layer, a development inhibitor (C) is preferably further contained. Particularly, when an infrared absorbing agent (B) used does not have a capacity to inhibit dissolution, this development inhibitor can be an important factor in maintaining the resistance to alkali of an image region.

The structure of the recording layer is not particularly limited and may be either a single-layer structure or a multi-layered structure consisting of multiple layers with various components. When the recording layer is a multi-layered structure, components (A) and (B) may be contained either in the same layer or in separate layers.

First, the constitution of the planographic printing plate precursor of the invention having a single-layer recording layer will be described in detail.

[Single-Layer Recording Layer]

[(A) Specific Alkali-Soluble Resin]

The specific alkali-soluble resin according to the invention can be used without particular limitation, as long as it is a polyamide resin, polyurea resin, polyurethane resin or polyester resin which has, as a repeating unit in a main chain of the polymer, a structural unit containing at least one type of bond (referred to hereinafter as a “specific bond”) selected from an amide bond, an urea bond, an urethane bond and an ester bond, and simultaneously has at least one type of acid group (referred to hereinafter as a “specific acid group”) selected from a phenolic hydroxyl group, a sulfonamide group and an active imide group.

In the specific alkali-soluble resin, the specific bond is essential for enhancing printing durability and chemical resistance as the effects of the invention. The specific bond in the invention is represented by the following formulae (1) to (4):

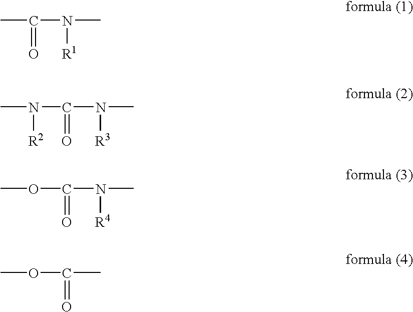

In formulae (1) to (4), R¹ to R⁴ each independently represents a hydrogen atom, an alkyl group or a carbonyl group, and when any one of R¹ to R⁴ is a carbonyl group, it may be bound to another functional group in the resin to form a cyclic imide structure. The alkyl group is a linear or branched alkyl group having in the order of 1 to 8 carbon atoms, preferably a methyl group, an ethyl group, an isopropyl group, a n-butyl group, an iso-butyl group, a tert-butyl group, a hexyl group and a 2-ethylhexyl group, particularly preferably a methyl group and an ethyl group.

Further, from the viewpoints of easiness of synthesis of the resulting resin and of printing durability and chemical resistance when the resin is used in a planographic printing plate, it is preferable that R¹ to R⁴ each represent a hydrogen atom. Among specific bonds represented by formulae (1) to (4), nitrogen-containing specific bonds (the amide bond, the urea bond, and the urethane bond) of formulae (1) to (3) are preferable, and the specific bond (amide bond) represented by the general formula (1) is particularly preferable.

The specific alkali-soluble resin of the invention should have at least one type of specific bond, and may have two kinds or more of specific bond.

The content of the specific bond contained in the specific alkali-soluble resin is preferably 0.5 to 10 meq/g (equivalent (unit: mmol) of the specific bond per 1 g of the resin), more preferably 1.5 to 9 meq/g, and still more preferably 2.5 to 8.5 meq/g.

The specific alkali-soluble resin, a major component of the recording layer, need be dissolvable in an alkali developer because the recording layer in the invention, upon irradiation with infrared rays, changes solubility thereof in the alkali developer, to form an image. To exhibit alkali solubility, the specific alkali-soluble resin has, as an alkali-soluble group in a side chain and/or a main chain of the polymer, at least one type of acid group (specific acid group) selected from a phenolic hydroxyl group (—Ar—OH), a sulfonamide group (—SO₂NH—R) and an active imide group (also called a “substituted sulfonamide acid group,” more specifically, —SO₂NHCOR, —SO₂NHSO₂R, or —CONHSO₂R etc.). In the formulae, Ar represents an optionally substituted divalent aryl linking group, and R represents an optionally substituted hydrocarbon group or a hydrogen atom.

The hydrocarbon group includes an alkyl group having 1 to 12 carbon atoms, a cycloalkyl group, an aryl group or an aralkyl group, among which an alkyl group having 1 to 8 carbon atoms or an aryl group is particularly preferable.

Examples of substituent group which can be introduced into the hydrocarbon group or the aryl group include an alkyl group, an alkoxy group, a hydroxyl group, a halogen atom, a cyano group, and a nitro group etc.

It is assumed that the specific acid group in the invention maintains high printing durability and chemical resistance which are characteristic of the specific alkali-soluble resin and has a higher pKa than that of a carboxyl group and the like used as an alkali soluble group in a general alkali-soluble resin, thus conferring excellent alkali solubility and not reducing the lipophilicity of an image region which is critical in the planographic printing plate.

From the viewpoints of easy introduction into the specific alkali-soluble resin and enhancement of printing durability and chemical resistance, as effects of the invention, the specific acid group is preferably a phenolic hydroxyl group or an active imide group, and a phenolic hydroxyl group is particularly preferable.

In the specific alkali-soluble resin, acid groups other than those described above can be simultaneously used to the extent that the printing durability, chemical resistance and lipophilicity of the recording layer are not diminished. Examples of such acid groups include a carboxyl group, a sulfonic acid group and a phosphoric acid group, and a carboxyl group is particularly preferable.

The content of the total of alkali-soluble groups including the specific acid groups and other acid groups, in the specific alkali-soluble resin, is preferably 1.0 to 10 meq/g, more preferably 2.0 to 9.0 meq/g, and still more preferably 2.5 to 8.5 meq/g.

Further, the content of the specific groups, relative to the total of alkali-soluble groups, including the specific acid groups and other acid groups is preferably 30% or more, more preferably 50% or more, and still more preferably 75% or more.

In the specific alkali-soluble resin according to the invention, in order to enhance the printing durability and chemical resistance of the recording layer, it is preferable that atoms constituting the main chain form a cyclic structure. The cyclic structure is preferably an aromatic ring structure or an alicyclic structure. Of the two, the aromatic ring structure is more preferable from the viewpoint of strength that can influence printing durability. The aromatic ring structure is preferably a phenylene skeleton consisting of a one ring structure or a structure having two phenylene skeletons linked therein, represented by the following formula (5):

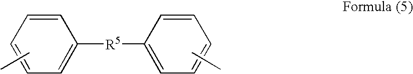

In formula (5), R⁵ represents a divalent organic group selected from a single bond, an oxygen atom, a sulfur atom, an alkylene group having 1 to 3 carbon atoms, a halogenated alkylene group having 1 to 3 carbon atoms, a carbonyl group, a sulfonyl group, a sulfoxyl group, an azo group, and a diothio group. From the viewpoint of enhancement of strength, R⁵ is particularly preferably a single bond, an oxygen atom or a methylene group, more preferably an oxygen atom or a methylene group. From the viewpoint of regulating the hydrophilicity, hydrophobicity and flocculation of the resin, R⁵ is also preferably an alkylene group having about 3 carbon atoms or a halogenated alkylene having about 3 carbon atoms. Preferable examples of R⁵ include:

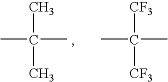

From the viewpoint of regulating the hydrophilicity, hydrophobicity and flocculation of the specific alkali-soluble resin, it is also preferable that in the structure represented by formula (5), a halogenated alkyl group represented by a fluorinated alkyl group, or an alkyl group having about 1 to 8 carbon atoms, is present at a position other than that of R⁵. The halogenated alkyl group is preferably a trifluoromethyl group, and the alkyl group is preferably an alkyl group (butyl group etc.) having about 4 carbon atoms.

The specific alkali-soluble resin can be obtained by known methods which include, but are not limited to, a method of directly condensing a polyamide by using a condensation agent, as described in Macromolecules, Vol. 21, No. 1, pp. 19-24 (1988), Polymer Journal, Vol. 20, No. 6, pp. 477-483 (1988), JP-A No. 2000-80344 etc.; a method of synthesizing a polybenzoxazole precursor, as described in J. Polym. Sci., Polym. Chem. Ed. Vol. 24, p. 1019 (1986), JP-A No. 2000-248077 etc.; and a method of synthesizing polyamide imide, as described in JP-A No. 2002-88154.

From the viewpoint of the strength and alkali solubility of the resin layer formed, the weight average molecular weight of the specific alkali-soluble resin in the invention is preferably about 1,000 to 200,000, more preferably about 2,000 to 150,000, and still more preferably about 5,000 to 120,000.

Because of the high flocculation of the specific alkali-soluble resin in the invention, the measurement of its molecular weight (Mw) by gel permeation chromatography (GPC) etc. is often difficult. In the following examples of the specific alkali-soluble resin, therefore, the logarithmic viscosity of the polymer is used as an indicator of molecular weight.

Because the viscosity of a resin solution varies depending on the structure of the resin, the logarithmic viscosity of the polymer may not correspond to the preferable molecular weight mentioned above. Generally speaking, however, the logarithmic viscosity is preferably about 0.05 to 3.0 dl/g, more preferably about 0.1 to 2.5 dl/g, and still more preferably about 0.2 to 2.5 dl/g.

The logarithmic viscosity of the polymer is determined at 30° C. by measuring the viscosity of a solution of the polymer dissolved in a concentration of 0.50 g/dl in N-methyl-2-pyrrolidone, and the viscosity of the solvent, with an Ubbellohde viscometer, and calculating the logarithmic viscosity according to the following equation: (Logarithmic viscosity)=In(solution viscosity/solvent viscosity)/(solution concentration)

Hereinafter, the specific alkali-soluble resin preferably used in the invention is illustrated, but the invention is not limited thereto. Furthermore, such alkali-soluble resins may be used alone or in mixtures of two or more thereof.

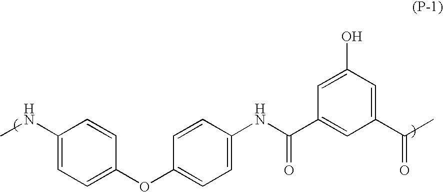

Logarithmic viscosity 0.75 dl/g (4,4′-oxydianiline/5-hydroxyisophthalic acid condensate)

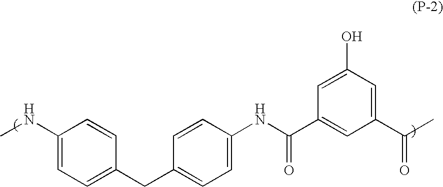

Logarithmic viscosity 0.68 dl/g (4,4′-diaminodiphenylmethane/5-hydroxyisophthalic acid condensate)

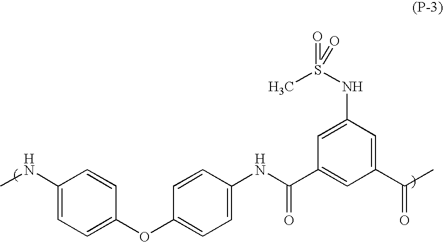

Logarithmic viscosity 0.61 dl/g (4,4′-oxydianiline/5-methylsulfonylaminoisophthalic acid condensate)

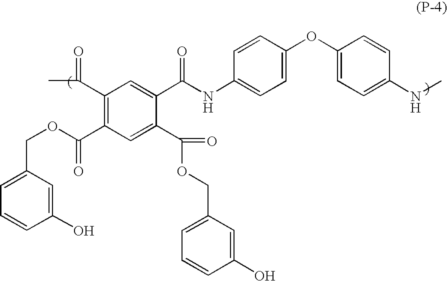

Logarithmic viscosity 0.77 dl/g (pyromellitic anhydride-3-hydroxybenzyl alcohol reaction product/4,4′-oxydianiline condensate, a mixture of isomers)

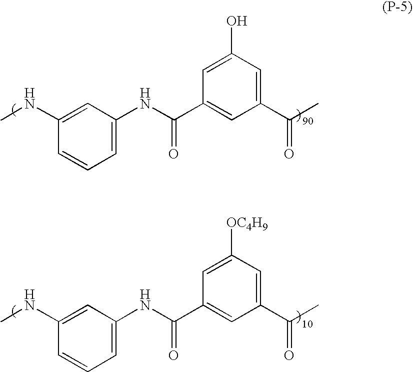

Logarithmic viscosity 0.91 dl/g (resin prepared by partially butylating, with di(n-butyl)sulfuric acid, a m-phenylenediamine/5-hydroxyisophthalic acid condensate)

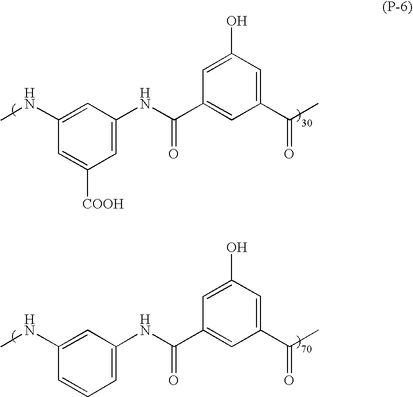

Logarithmic viscosity 0.96 dl/g (m-phenylenediamine/3,5-diaminobenzoic acid/5-hydroxyisophthalic acid condensate)

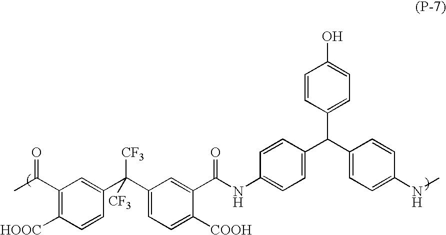

Logarithmic viscosity 0.83 dl/g (4,4′-diamino-4″-hydroxytriphenylmethane/4,4′-hexafluoroisopropylidene diphthalic anhydride condensate)

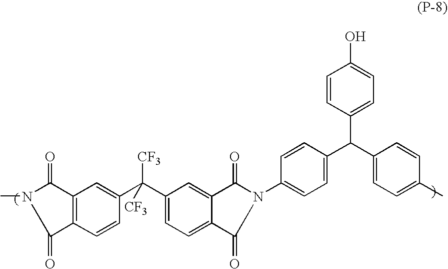

Logarithmic viscosity 0.56 dl/g (resin prepared by heating and imidating a 4,4′-diamino-4″-hydroxytriphenylmethane/4,4′-hexafluoroisopropylidene diphthalic anhydride condensate)

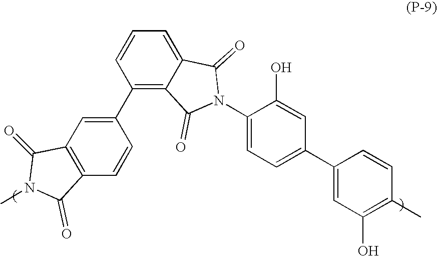

Logarithmic viscosity 0.51 dl/g (resin prepared by heating and imidating a 2,3,3′,4′-biphenyltetracarboxylic anhydride/3,3′-dihydroxybenzidine condensate)

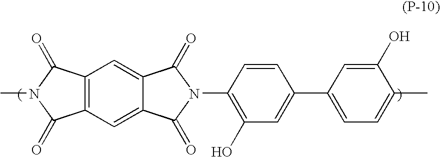

Logarithmic viscosity 0.44 dl/g (resin prepared by heating and imidating a pyromellitic anhydride/3,3′-dihydroxybenzidine condensate)

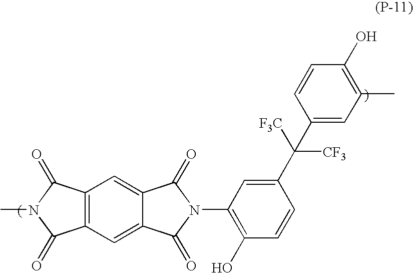

Logarithmic viscosity 0.35 dl/g (resin prepared by heating and imidating a pyromellitic anhydride/2,2-bis(3-amino-4-hydroxyphenyl) hexafluoropropane condensate)

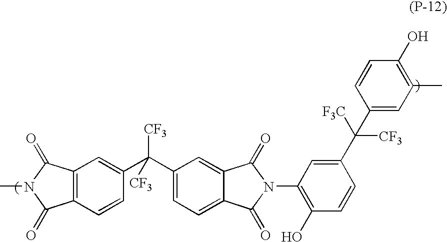

Logarithmic viscosity 0.31 dl/g (resin prepared by heating and imidating 4,4′-hexafluoroisopropylidene diphthalic anhydride/2,2-bis(3-amino-4-hydroxyphenyl)hexafluoropropane condensate)

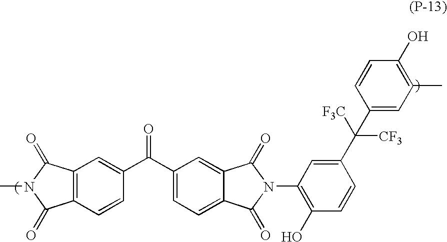

Logarithmic viscosity 0.49 dl/g (resin prepared by heating and imidating 3,3′,4,4′-benzophenonetetracarboxylic dianhydride/2,2-bis(3-amino-4-hydroxyphenyl)hexafluoropropane condensate)

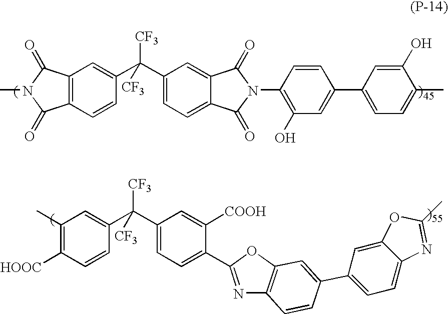

Logarithmic viscosity 0.55 dl/g (resin prepared by heating and decylization of 4,4′-hexafluoroisopropylidene diphthalic anhydride/3,3′-dihydroxybenzidine condensate)

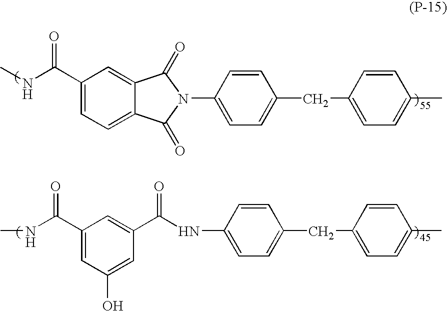

Logarithmic viscosity 0.47 dl/g (trimellitic anhydride/5-hydroxyisophthalic acid/4,4′-diphenylmethane diisocyanate condensate)

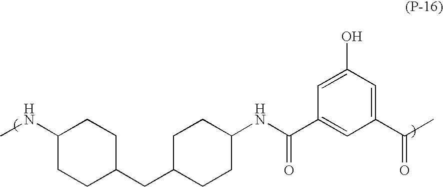

Logarithmic viscosity 0.35 dl/g (bis(4-aminocyclohexyl) methane/5-hydroxyisophthalic acid condensate)

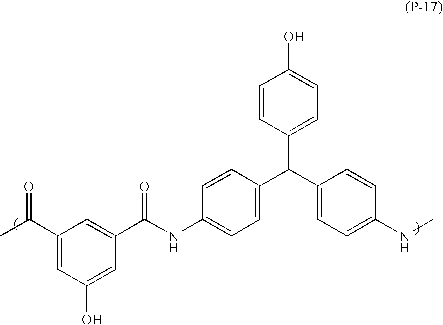

Logarithmic viscosity 0.71 dl/g (4,4′-diamino-4″-hydroxytriphenylmethane/5-hydroxyisophthalic acid condensate)

Relative to the total solids content of the recording layer, the content of the specific alkali-soluble resin in the single-layer(-type) recording layer in the planographic printing plate precursor of the invention is preferably 50 to 96% by mass, more preferably 60 to 93% by mass, and still more preferably 65 to 91% by mass. Within this range, the recording layer is excellent in terms of printing durability, chemical resistance and image formability.

In the single-layer recording layer in the invention, an alkali soluble resin other than the specific alkali-soluble resin may be simultaneously used. The alkali-soluble resin which can be simultaneously used is a coneventional alkali-soluble resin, preferably novolak resin, used in a multi-layered recording layer (upper layer) described later. Relative to the total amount of the alkali-soluble resins, the ratio of the general alkali-soluble resin mixed is preferably not higher than 40% by mass, more preferably not higher than 35% by mass, and still more preferably not higher than 30% by mass.

[Infrared Absorbing Agent(B)]

Infrared absorbing agent (B) should be added to the single-layer recording layer in the invention. The infrared absorbing agent used in the invention is not particularly limited as long as it is a dye absorbing infrared rays to generate heat. Various dyes known as infrared absorbing agents can be used. In particular, in order to reduce substantially the solubility of the binder resin in a developer, an infrared absorbing agent interacting with the binder resin such as the specific alkali-soluble resin and novolak resin is preferably used, and for example, a cyanine colorant can be mentioned as one having an outstanding capacity to inhibit dissolution.

As the infrared absorbing agent in the invention, known dyes can be employed such as those commercially available and described in literature (for example “Senryo Binran” (Dye Handbook) published in 1970 and compiled by the Society of Synthetic Organic Chemistry, Japan). Examples of such dyes include azo dyes, metal complex salt azo dyes, pyrazolone azo dyes, anthraquinone dyes, phthalocyanine dyes, carbonium dyes, quinone imine dyes, methine dyes, and cyanine dyes. Insofar that the dyes are applied to lasers emitting infrared rays or near infrared rays, among the dyes listed above, those absorbing infrared rays or near infrared rays are particularly preferable in the invention.

The dyes absorbing infrared rays or near infrared rays include for example cyanine dyes described in JP-A Nos. 58-125246, 59-84356, 59-202829 and 60-78787; methine dyes described in JP-A Nos. 58-173696, 58-181690, 58-194595 etc.; naphthoquinone dyes described in JP-A Nos. 58-112793, 58-224793, 59-48187, 59-73996, 60-52940, 60-63744 etc.; squarylium dyes described in JP-A No. 58-112792 etc.; and cyanine dyes described in UK Patent No. 434,875.

Further, a near infrared-absorbing sensitizer described in U.S. Pat. No. 5,156,938 is preferably used as the dye. Also preferably used are substituted aryl benzo (thio)pyrylium salts described in U.S. Pat. No. 3,881,924; trimethine thiapyrylium salts described in JP-A No. 57-142645 (U.S. Pat. No. 4,327,169); pyrylium type compounds described in JP-A Nos. 58-181051, 58-220143, 59-41363, 59-84248, 59-84249, 59-146063 and 59-146061; cyanine pigments described in JP-A No. 59-216146, pentamethine thiopyrylium salts described in U.S. Pat. No. 4,283,475; and pyrylium compounds disclosed in Japanese Patent Application Publication (JP-B) Nos. 5-13514 and 5-19702. Epolight III-178, Epolight III-130, Epolight III-125 etc. available from Epoline Co., Ltd. can be particularly preferably used as commercial products.

Other particularly preferable examples of the dyes include near infrared ray-absorbing dyes of formulae (I) and (II) described in U.S. Pat. No. 4,756,993.

The infrared absorbing agent may be added to the same layer as the recording layer or to another separately arranged layer. When the infrared absorbing agent is added to another layer, it is preferably added to a layer adjacent to the recording layer.

When the infrared absorbing agent is a compound having a capacity to inhibit dissolution, the infrared absorbing agent is added preferably to the layer containing the specific alkali-soluble resin so that the infrared absorbing agent can perform a dual function, not only in light/heat conversion but also as a development inhibitor.

From the viewpoint of sensitivity and durability (film property) of the recording layer, the amount of the infrared absorbing agent added is preferably about 0.01 to 50% by mass, and more preferably about 0.1 to 10% by mass relative to the total solids content of the single-layer recording layer.

[Development Inhibitor(C)]

For the purpose of enhancing its inhibition (capacity to inhibit dissolution), the recording layer in the invention preferably contains development inhibitor (C). Particularly when the infrared absorbing agent used does not have a capacity to inhibit dissolution, this development inhibitor can be an important factor in maintaining the alkali resistance of an image region.

The development inhibitor used in the invention is not particularly limited, so long as it interacts with the specific alkali-soluble resin, or with the other alkali-soluble resin, thereby reducing substantially the dissolution, in a developer, of the alkali-soluble resin in a light-unexposed region while at the same time moderating the interaction, in a light-exposed region, to make that region soluble in a developer. In particular, quaternary ammonium salts, polyethylene glycol compounds etc. are preferably used.

Image-coloring agents described later, include compounds functioning as a development inhibitor, and such compounds are also preferable.

The quaternary ammoniums include, but are not limited to, tetraalkyl ammonium salts, trialkyl aryl ammonium salts, dialkyl diaryl ammonium salts, alkyl triaryl ammonium salts, tetraaryl ammonium salts, cyclic ammonium salts and dicyclic ammonium salts.

Specific examples include tetrabutyl ammonium bromide, tetrapentyl ammonium bromide, tetrahexyl ammonium bromide, tetraoctyl ammonium bromide, tetralauryl ammonium bromide, tetraphenyl ammonium bromide, tetranaphthyl ammonium bromide, tetrabutyl ammonium chloride, tetrabutyl ammonium iodide, tetrastearyl ammonium bromide, lauryltrimethyl ammonium bromide, stearyltrimethyl ammonium bromide, behenyltrimethyl ammonium bromide, lauryltriethyl ammonium bromide, phenyltrimethyl ammonium bromide, 3-trifluoromethylphenyltrimethyl ammonium bromide, benzyltrimethyl ammonium bromide, dibenzyldimethyl ammonium bromide, distearyldimethyl ammonium bromide, tristearylmethyl, ammonium bromide, benzyltriethyl ammonium bromide, hydroxyphenyltrimethyl ammonium bromide and N-methylpyridinium bromide. In particular, quaternary ammonium salts described in Japanese Patent Application Nos. 2001-226297, 2001-370059 and 2001-398047 are preferable.

From the viewpoints of effectiveness inhibiting development and at the same time enabling the alkali-soluble resin to form films satisfactorily, the amount of quaternary ammonium salts added is preferably 0.1 to 25% by mass, and more preferably 0.1 to 15% by mass relative to the total solids content of the single-layer recording layer.

Examples of the polyethylene glycol compounds include, but are not limited to, those having the structure represented by the following formula (I): Formula (I)
R¹—(—O—(R³—O—)ₘ—R²)ₙ
wherein R¹ represents a polyvalent alcohol residue or a polyvalent phenol residue, R² represents a hydrogen atom, an optionally substituted C1 to C25 alkyl, alkenyl, alkynyl, alkyloyl, aryl or acryloyl group, R³ represents an optionally substituted alkylene residue, m is on average an integer of 10 or more, and n is an integer of 1 to 4.

Examples of polyethylene glycol compounds represented by formula (I) include polyethylene glycols, polypropylene glycols, polyethylene glycol alkyl ethers, polypropylene glycol alkyl ethers, polyethylene glycol aryl ethers, polypropylene glycol aryl ethers, polyethylene glycol alkyl aryl ethers, polypropylene glycol alkyl aryl ethers, polyethylene glycol glycerin ester, polypropylene glycol glycerin esters, polyethylene sorbitol esters, polypropylene glycol sorbitol esters, polyethylene glycol fatty esters, polypropylene glycol fatty esters, polyethylene glycol ethylene diamines, polypropylene glycol ethylene diamines, polyethylene glycol diethylene triamines and polypropylene glycol diethylene triamines.

Further specific examples include polyethylene glycol 1000, polyethylene glycol 2000, polyethylene glycol 4000, polyethylene glycol 10000, polyethylene glycol 20000, polyethylene glycol 5000, polyethylene glycol 100000, polyethylene glycol 200000, polyethylene glycol 500000, polypropylene glycol 1500, polypropylene glycol 3000, polypropylene glycol 4000, polyethylene glycol methyl ether, polyethylene glycol ethyl ether, polyethylene glycol phenyl ether, polyethylene glycol dimethyl ether, polyethylene glycol diethyl ether, polyethylene glycol diphenyl ether, polyethylene glycol lauryl ether, polyethylene glycol dilauryl ether, polyethylene glycol nonyl ether, polyethylene glycol cetyl ether, polyethylene glycol stearyl ether, polyethylene glycol distearyl ether, polyethylene glycol behenyl ether, polyethylene glycol dibehenyl ether, polypropylene glycol methyl ether, polypropylene glycol ethyl ether, polypropylene glycol phenyl ether, polypropylene glycol dimethyl ether, polypropylene glycol diethyl ether, polypropylene glycol diphenyl ether, polypropylene glycol lauryl ether, polypropylene glycol dilauryl ether, polypropylene glycol nonyl ether, polyethylene glycol acetyl ester, polyethylene glycol diacetyl ester, polyethylene glycol benzoate, polyethylene glycol lauryl ester, polyethylene glycol dilauryl ester, polyethylene glycol nonylate, polyethylene glycol cetylate, polyethylene glycol stearoyl ester, polyethylene glycol distearoyl ester, polyethylene glycol behenate, polyethylene glycol dibehenate, polypropylene glycol acetyl ester, polypropylene glycol diacetyl ester, polypropylene glycol benzoate, polypropylene glycol dibenzoate, polypropylene glycol laurate, polypropylene glycol dilaurate, polypropylene glycol nonylate, polyethylene glycol glycerin ether, polypropylene glycol glycerin ether, polyethylene glycol sorbitol ether, polypropylene glycol sorbitol ether, polyethylene glycol ethylene diamine, propylene glycol ethylene diamine, polyethylene glycol diethylene triamine, polypropylene glycol diethylene triamine and polyethylene glycol pentamethylene hexamine.

From the viewpoint of effectiveness in preventing development and at the same time assuring mage formability, the amount of polyethylene glycol compound added is preferably 1 to 25% by mass, and more preferably 3 to 15% by mass relative to the total solids content of the single-layer recording layer.

When modification is done to increase such inhibition (capacity to inhibit dissolution), sensitivity is reduced, but in these circumstances, addition of a lactone compound to the recording layer is effective in curbing this reduction in sensitivity. It is assumed that, when the developer penetrates to the recording layer in a light-exposed region, that is, a region in which inhibition has been neutralized, the lactone compound enhances sensitivity by reacting with the developer to generate a carboxylic acid compound and thus promote the dissolution of the recording layer in the light-exposed region. Moreover, in a light-unexposed region, this lactone compound interacts with a polar group in the alkali-soluble resin, for example a hydroxyl group in the novolak resin, and, because it has a bulky structure with a ring, it can exist stably in a film so that even when the surface of the light-unexposed region is brought into contact with the alkali developer, the rapid ring-opening reaction of the lactone ring is suppressed during the development treatment, and thus the development resistance of the region does not deteriorate. This interaction is neutralized more easily, than the inhibitory action achieved by the development inhibitor, by means of light exposure or heating, and thus in the light-exposed region the ring-opening reaction of the lactone compound proceeds rapidly.

Such lactone compounds include, but are not limited to, compounds represented by the following formulae (L-I) and (L-II):

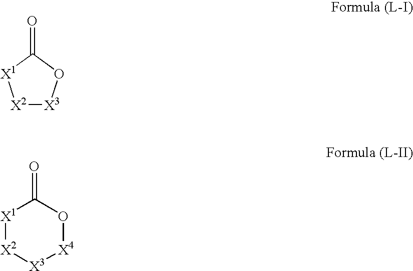

In formulae (L-I) and (L-II), X¹, X², X³ and X⁴ may be the same as, or different from, each other, and each represents a divalent nonmetallic atom or a nonmetallic atomic group constituting the ring. Each of these groups may independently have a substituent group. Moreover, at least one of X¹, X² and X³ in formula (L-I) and at least one of X¹, X², X³ and X⁴ in formula (L-II) are each preferably an electron-withdrawing substituent group or a substituent group substituted with an electron-withdrawing group.

The nonmetallic atom or nonmetallic atomic group is preferably an atom or an atomic group selected from a methylene group, a sulfinyl group, a carboxyl group, a thiocarbonyl group, a sulfonyl group, a sulfur atom, an oxygen atom and a selenium atom, more preferably an atomic group selected from a methylene group, a carbonyl group and a sulfonyl group.

The electron-withdrawing substituent group in the specification refers to a group whose Hammett's substituent constant σp is a positive value. With respect to the Hammett's substituent constant, the Journal of Medicinal Chemistry, 1973, Vol. 16, No. 11, 1207-1216 etc. is regarded as a source of reference.

The electron-withdrawing group whose Hammett's substituent constant up is a positive value includes, for example, a halogen atom [fluorine atom (σp value: 0.06), a chlorine atom (σp value: 0.23), a bromine atom (σp value: 0.23), an iodine atom (σp value: 0.18)], a trihaloalkyl group [tribromomethyl (σp value: 0.29), trichloromethyl (σp value: 0.33), trifluoromethyl (σp value: 0.54)], a cyano group (σp value: 0.66), a nitro group (σp value: 0.78), an aliphatic/aryl or heterocyclic sulfonyl group [for example, methanesulfonyl (σp value: 0.72)], an aliphatic/aryl or heterocyclic acyl group [for example, acetyl (σp value: 0.50), benzoyl (σp value: 0.43)], an alkynyl group [for example, C═CH (σp value: 0.23)], an aliphatic/aryl or heterocyclic oxycarbonyl group [for example, methoxycarbonyl (σp value: 0.45), phenoxycarbonyl (σp value: 0.44)], a carbamoyl group (σp value: 0.36), a sulfamoyl group (σp value: 0.57), a sulfoxide group, a heterocyclic group, an oxo group and a phosphoryl group.

The electron-withdrawing group is preferably a group selected from an amide group, an azo group, a nitro group, a C1 to C5 fluoroalkyl group, a nitrile group, a C1 to C5 alkoxycarbonyl group, a C1 to C5 acyl group, a C1 to C9 alkylsulfonyl group, a C6 to C9 arylsulfonyl group, a C1 to C9 alkylsulfinyl group, a C6 to C9 arylsulfinyl group, a C6 to C9 arylcarbonyl group, a thiocarbonyl group, a C1 to C9 fluorine-containing alkyl group, a C6 to C9 fluorine-containing aryl group, a C3 to C9 fluorine-containing allyl group, an oxo group and a halogen atom, and more preferably a group selected from a nitro group, a C1 to C5 fluoroalkyl group, a nitrile group, a C1 to C5 alkoxycarbonyl group, a C1 to C5 acyl group, a C6 to C9 arylsulfonyl group, a C6 to C9 arylcarbonyl group, an oxo group and a halogen atom.

Hereinafter, examples of compounds represented by formulae (L-I) and (L-II) are described, but the invention is not limited to such compounds.

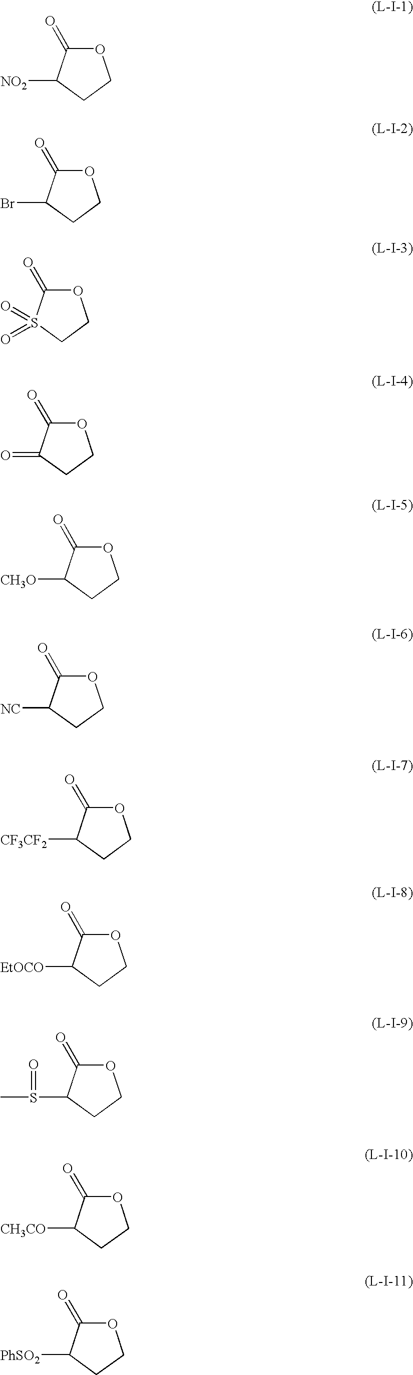

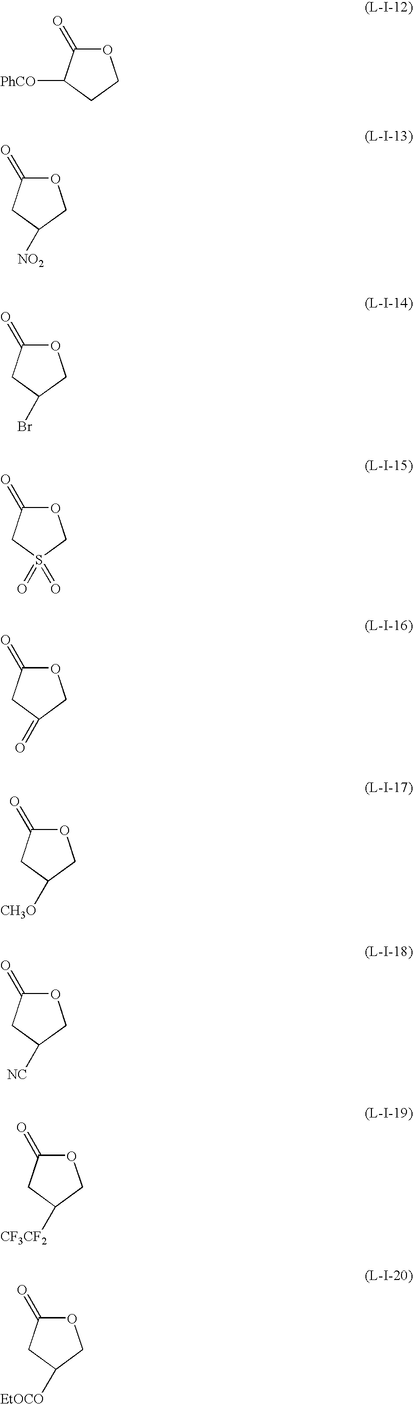

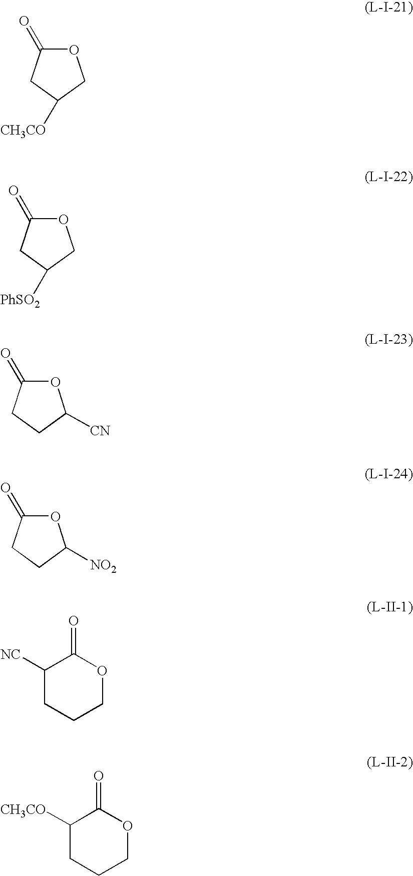

From the viewpoints of ease in the adding process and the effects of image formability, the amount of compounds represented by formulae (L-I) and (L-II) added is preferably 0.1 to 10% by mass, more preferably 0.2 to 6% by mass relative to the total solids content of the single-layer recording layer.

The lactone compounds used in the invention may be used alone or in combinations of two or more thereof. When two or more kinds of compound in formula (L-I), or two or more kinds of compound in formula (L-II) are used, these compounds can be used simultaneously in an arbitrary ratio, as long as the total amount of compounds added remains within the above range.

In addition, onium salts, o-quinone diazide compounds, aromatic sulfone compounds and aromatic sulfonate compounds, which are thermally decomposable and, in a non-decomposed state, substantially reduce the solubility of the alkali-soluble resin, are preferably simultaneously used in order to enhance the inhibition of an image region in a developer.

The onium salts used in the invention include diazonium salts, ammonium salts, phosphonium salts, iodonium salts, sulfonium salts, selenium salts and arsonium salts. Particularly preferable examples include diazonium salts described in S. I. Schlesinger, Photogr. Sci. Eng., 18, 387 (1974), T. S. Bal et al., Polymer, 21, 423 (1980), and JP-A No. 5-158230, ammonium salts described in U.S. Pat. Nos. 4,069,055 and 4,069,056, and JP-A No.3-140140; phosphonium salts described in D. C. Necker et al., Macromorecules, 17, 2468 (1984), C. S. Wen et al., Teh, Proc. Conf. Rad. Curing ASIA, p. 478, Tokyo, Oct (1988) and U.S. Pat. Nos. 4,069,055 and 4,069,056; iodonium salts described in J. V. Crivello et al., Macromolecules, 10(6), 1307 (1977), Chem. & Eng. News, Nov. 28, p. 31 (1988), EP Patent No. 104,143, U.S. Pat. Nos. 5,041,358 and 4,491,628, JP-A No. 2-150848 and JP-A No. 2-296514; sulfonium salts described in J. V. Crivello et al., Polymer J. 17, 73 (1985), J. V. Crivello et al. J. Org. Chem., 43, 3055 (1978), W. R. Watt et al., J. Polymer Sci., Polymer Chem. Ed., 22, 1789 (1984), J. V. Crivello et al., Polymer Bull., 14, 279 (1985), J. V. Crivello et al., Macromorecules, 14(5), 1141 (1981), J. V. Crivello et al., J. Polymer Sci., Polymer Chem. Ed., 17, 2877 (1979), EU Patent Nos. 370,693, 233,567, 297,443 and 297,442, U.S. Pat. Nos. 4,933,377, 3,902,114, 4,491,628, 4,760,013, 4,734,444 and 2,833,827, and German Patent Nos. 2,904,626, 3,604,580 and 3,604,581; selenonium salts described in J. V. Crivello et al., Macromolecules, 10(6), 1307 (1977) and J. V. Crivello et al., J. Polymer Sci., Polymer Chem. Ed., 17, 1047 (1979); and arsonium salts described in C. S. Wen et al., Teh, Proc. Conf. Rad. Curing ASIA, p. 478, Tokyo, Oct (1988).

Among these onium salts, diazonium salts are particularly preferable. Particularly preferable diazonium salts include those described in JP-A No. 5-158230.

Counter ions for the onium salts include tetrafluoboric acid, hexafluophosphoric acid, triisopropyl naphthalene sulfonic acid, 5-nitro-o-toluene sulfonic acid, 5-sulfosalicylic acid, 2,5-dimethyl benzene sulfonic acid, 2,4,6-trimethyl benzene sulfonic acid, 2-nitrobenzene sulfonic acid, 3-chlorobenzene sulfonic acid, 3-bromobenzene sulfonic acid, 2-fluoroacrylic naphthalene sulfonic acid, dodecyl benzene sulfonic acid, 1-naphthol-5-sulfonic acid, 2-methoxy-4-hydroxy-5-benzoyl-benzene sulfonic acid, and p-toluene sulfonic acid. Among these, hexafluophosphoric acid and alkyl aromatic sulfonic acids such as triisopropyl naphthalene sulfonic acid and 2,5-dimethyl benzene sulfonic acid are particularly preferable.

Preferable quinonediazides include o-quinonediazide compounds. The o-quinondiazide compound used in the invention is a compound having at least one o-quinonediazide group which increases alkali solubility upon pyrrolysis, and compounds having various structures can be used. In other words, both by means of pyrrolysis and by at the same time changing itself into an alkali-soluble substance o-quinone diazide facilitates dissolution of the upper layer by eliminating the inhibition of the upper layer as a development inhibitor.

As o-quinone diazide compounds, compounds described for example on pages 339 to 352 of Light-Sensitive Systems wrriten by J. Coser (John Wiley & Sons. Inc.) can be used, and in particular o-quinone diazide sulfonates or sulfonic amides which have reacted with various aromatic polyhydroxy compounds or aromatic amino compounds are preferable. Further, esters between benzoquinone(1,2)-diazide sulfonic acid chloride or naphthoquinone-(1,2)-diazide-5-sulfonic acid chloride and pyrogallol-acetone resin described in JP-B No. 43-28403, and esters between benzoquinone-(1,2-diazide sulfonic acid chloride or naphthoquinone-(1,2)-diazide-5-sulfonic acid chloride and phenol-formamide resin described in U.S. Pat. Nos. 3,046,120 and 3,188,210 are also preferably used.

Further, esters between naphthoquinone-(1,2)-diazo-4-sulfonic acid chloride and phenol formaldehyde resin or cresol-formaldehyde resin, and esters between naphthoquinone-(1,2)-diazide-4-sulfonic acid chloride and pyrogallol-acetone resin, can like wise also be preferably used. Other useful o-quinone diazide compounds are reported and known in a large number of patents. Examples include those described in JP-A Nos. 47-5303, 48-63802, 48-63803, 48-96575, 49-38701, JP-A No.48-13354, JP-B Nos. 41-11222,45-9610, 49-17481, U.S. Pat. Nos. 2,797,213, 3,454,400, 3,544,323, 3,573,917, 3,674,495 and 3,785,825, UK Patent Nos. 1,227,602, 1,251,345, 1,267,005, 1,329,888 and 1,330,932 and German Patent No. 854,890.

The amount of o-quinone diazide compounds added is in the range of preferably 0.1 to 8% by mass, and more preferably 0.2 to 5% by mass relative to the total solids content of the single-layer recording layer. These compounds can be used individually in mixtures thereof.

Further, an at least partially esterified alkali-soluble resin described in JP-A No. 11-288089 may also be included.

For the purpose of enhancing both inhibition of the surface of the recording layer and resistance to surface mar, a polymer having, as a polymerizable component, a (meth)acrylate monomer with two or three C3 to C20 perfuloroalkyl groups in a molecule, as described in JP-A No. 2000-187318, is preferably simultaneously used.

Relative to the total solids content of the single-layer recording layer, the amount of polymer added is in range of preferably 0.5 to 15% by mass, and more preferably 1 to 10% by mass,.

[Other Additives]

In addition to the essential components described above, various additives may if necessary be added for formation of the single-layer recording layer in the invention, as long as the effects of the invention are not diminished.

<Development Accelerator>

For the purpose of enhancing sensitivity, acid anhydrides, phenols and organic acids may be added to the single-layer recording layer in the invention.

The acid anhydrides are preferably cyclic acid anhydrides, and specifically, it is possible to use cyclic acid anhydrides, as described in U.S. Pat. No. 4,115,128, such as phthalic anhydride, tertrahydrophthalic anhydride, hexahydrophthalic anhydride, 3,6-endoxy-tetrahydrophthalic anhydride, tetrachlorophthalic anhydride, maleic anhydride, chloromaleic anhydride, α-phenylmaleic anhydride, succinic anhydride and pyromellitic anhydride. Non-cyclic acid anhydrides which can be used include acetic anhydride.

The phenol derivatives include bisphenol A, 2,2′-bishydroxysulfone, p-nitrophenol, p-ethoxyphenol, 2,4,4′-trihydroxybenzophenone, 2,3,4-trihydroxybenzophenone, 4-hydroxybenzophenone, 4,4′,4″-trihydroxytriphenylmethane, and 4,4′,3″,4″-tetrahydroxy-3,5,3,′,5′-tetramethyltriphenylmethane.

The organic acids include those described in JP-A Nos. 60-88942 and JP-A No. 2-96755, such as sulfonic acids, sulfinic acids, alkyl sulfuric acids, phosphonic acids, phosphates and carboxylic acids. Specifically, mention is made of p-toluene sulfonic acid, dodecyl benzene sulfonic acid, p-toluene sulfinic acid, ethyl sulfuric acid, phenyl phosphonic acid, phenyl phosphinic acid, phenyl phosphate, diphenyl phosphate, benzoic acid, isophthalic acid, adipic acid, p-toluic acid, 3,4-dimethoxybenzoic acid, phthalic acid, terephthalic acid, 4-cyclohexene-1,2-dicarboxylic acid, erucic acid, lauric acid, n-undecanoic acid and ascorbic acid.

Relative to the total solids content of the single-layer recording layer, the amount of acid anhydrides, phenols and organic acids is preferably 0.05 to 20% by mass, and more preferably 0.1 to 15% by mass, still more preferably 0.1 to 10% by mass.

<Surfactants>

To improve coating properties and stability in treatment under developing conditions, nonionic surfactants described in JP-A Nos. 62-251740 and 3-208514, amphoteric surfactants described in JP-A Nos. 59-121044 and 4-13149, siloxane compounds described in EP950517, and fluorine-containing monomer copolymers described in JP-A Nos. 62-170950, 11-288093 and Japanese Patent Application No. 2001-247351 can be added.

Examples of nonionic surfactants include sorbitan tristearate, sorbitan monopalmitate, sorbitan trioleate, stearate monoglyceride, polyoxyethylene nonyl phenyl ether etc. Examples of the amphoteric surfactants include alkyl di(aminoethyl)glycine, alkyl polyaminoethyl glycine hydrochloride, 2-alkyl-N-carboxyethyl-N-hydroxyethyl imidazolium betaine and N-tetradecyl-N,N-betaine type surfactants (e.g. trade name: Amogen K, Dai-Ichi Kogyo Co., Ltd.).

The siloxane compound is preferably a dimethylsiloxane/polyalkylene oxide block copolymer, and specific examples include polyalkylene oxide-modified silicone such as DBE-224, DBE-621, DBE-712, DBP-732 and DBP-534 manufactured by Chisso Corporation, and Tego Glide 100 manufactured by Tego, Germany.

Relative to the total solids content of the single-layer recording layer the proportion of nonionic surfactants and amphoteric surfactant is preferably 0.01 to 15% by mass, more preferably 0.1 to 5.0% by mass, and still more preferably 0.5 to 2.0% by mass.

<Printing Agents/Colorants>

A printing agent for producing a visible image immediately after heating by exposure to light, and a dye or pigment as an image-coloring agent can be added to the single-layer recording layer in the invention.

The printing agent is typically a combination of a compound releasing an acid by heating with exposure to light (optically acid releasing agent) and an organic dye capable of forming a salt. Specifically, mention is made of a combination of o-naphthoquinonediazide-4-sulfonic acid halogenide and a salt-forming organic dye, as described in JP-A Nos. 50-36209 and 53-8128, and a combination of a trihalomethyl compound and a salt-forming organic dye, as described in JP-A Nos. 53-36223, 54-74728, 60-3626, 61-143748, 61-151644 and 63-58440. The trihalomethyl compound includes an oxazole compound and a triazine compound, both of which are excellent in terms of stability over a passage of time and give a clear print image.

As the image-coloring agent, dyes other than the salt-forming organic dyes mentioned above can be used. As preferable dyes including the salt-forming organic dyes, mention is made of oil-soluble dyes and basic dyes. Specific examples include Oil Yellow #101, Oil Yellow #103, Oil Pink #312, Oil Green BG, Oil Blue BOS, Oil Blue #603, Oil Black BY, Oil Black BS, Oil Black T-505 (trade name, manufactured by Orient Kagaku Kogyo Co., Ltd.), Victoria Pure Blue, Crystal Violet Lactone, Crystal Violet (CI42555), Methyl Violet (CI42535), Ethyl Violet, Rhodamine B (CI145170B), Malachite Green (CI42000), Methylene Blue (CI52015) etc. Further, the dyes described in JP-A No. 62-293247 are particularly preferable.

Relative to the total solids content of the single-layer recording layer, these dyes can be added in an amount of 0.01 to 10% by mass, and more preferably 0.1 to 3% by mass.

<Plasticizers>

A plasticizer may be added to the single-layer recording layer in the invention in order to endow a film with flexibility etc. Examples of the plasticizer used include oligomers or polymers of butyl phthalyl, polyethylene glycol, tributyl citrate, diethyl phthalate, dibutyl phthalate, dihexyl phthalate, dioctyl phthalate, tricresyl phosphate, tributyl phosphate, trioctyl phosphate, tetrahydrofurfuryl oleate, acrylic or methacrylic acid.

Relative to the total solids content of the single-layer recording layer, these plasticizers can be added in an amount of 0.5 to 10% by mass, and preferably 1.0 to 5% by mass.

<Waxing Agents>

For the purpose of conferring mar resistance, a compound capable of reducing the coefficient of static friction on the surface can be added to the single-layer recording layer in the invention, specifically, compounds having long-chain alkyl carboxylates, as described in U.S. Pat. No. 6,117,913, or in Japanese Patent Application Nos. 2001-261627, 2002-032904 and 2002-165584 which have been previously proposed by the present applicant.

Relative to the total solids content of the single-layer recording layer, the amount of waxing agent added is preferably 0.1 to 10% by mass, and more preferably 0.5 to 5% by mass,

[Multi-Layered Recording Layer]

As essential components in the recording layer of the invention specific alkali-soluble resin (A) and infrared absorbing agent (B) may be contained in the same layer or in separate layers. The planographic printing plate precursor having a multi-layered structure, which is a particularly preferable embodiment in the invention, is one having a lower layer containing specific alkali-soluble resin (A) and an upper layer containing an alkali-soluble resin and which is capable of forming an image by irradiation with infrared rays, wherein the lower layer and/or the upper layer in the recording layer contains infrared absorbing agent (B). Hereinafter, such a preferable multi-layered recording layer is described in detail.

[Lower Layer Containing Specific Alkali-Soluble Resin (A)]

The lower layer in the invention is characterized by containing specific alkali-soluble resin (A) mentioned above. As described above, the specific alkali-soluble resin used herein is not particularly limited, as long as it has a structural unit containing the specific bond as a repeating unit in a main chain of the polymer, and has the specific acid group.

Relative to the total solids content of the lower layer recording layer, the content of the specific alkali-soluble resin in the lower layer of the multi-layered recording layer is preferably 50 to 100% by mass, more preferably 60 to 98% by mass, and still more preferably 65 to 95% by mass. Within this range, the recording layer is excellent in terms of printing durability, chemical resistance, and image formability.

In the lower layer of the recording layer, the specific alkali-soluble resin may be used exclusively as the binder resin, but from the viewpoint of an improvement in film properties, other resins may be used in combination with the specific alkali-soluble resin, within a range where the effects of the invention do not diminish. The lower layer itself is required to exhibit alkali solubility, particularly in a non-image region, and thus a resin should be selected in which this property is not impaired.

From this viewpoint, as a resin for use in combination, an alkali-soluble resin other than the specific alkali-soluble resin can be considered. Alkali-soluble resins which can be used in combination with the specific alkali-soluble resin include as a component in the upper layer a general alkali-soluble resin described later. Particularly preferable examples include a polyamide resin, an epoxy group-containing resin, a polyvinyl acetal resin, an acryl resin, a methacryl resin, a polystyrene resin, a novolak phenol resin and a polyurethane resin.

Relative to the total alkali-soluble resin contained in the lower layer, the general alkali-soluble resin is mixed in an amount of not more than 40% by mass, more preferably not more than 35% by mass, and still more preferably not more than 30% by mass.

If necessary, an infrared absorbing agent and other additives can be used as components in the lower layer in the invention. Examples of the other additives include a development accelerator, a surfactant, a printing agent/colorant, a plasticizer, and a waxing agent. Details of these components are identical to those of components in the upper layer described later.

[Upper Layer Containing an Alkali-Soluble Resin and Capable of Forming an Image by Irradiation with Infrared Rays]

The upper layer in the invention is characterized by containing an alkali-soluble resin and being capable of forming an image by irradiation with infrared rays.

(Alkali-Soluble Resin)

The alkali-soluble resin which can be used in the upper layer in the invention is not particularly limited, as long as the resin is inherently dissolvable upon contact with an alkaline developer. The alkali-soluble resin is preferably a homopolymer or a copolymer, or a mixture thereof having an acidic group in a main chain and/or a side chain of the polymer. The specific alkali-soluble resin can also be added to the upper layer.

Such an alkali-soluble resin having an acidic group is particularly preferably a polymer compound having, in a molecule, one functional group selected from (1) a phenolic hydroxyl group, (2) a sulfonamide group, (3) an active imide group, (4) an carboxylic acid group and (5) a phosphoric acid group. Among then a polymer compound having a phenolic hydroxyl group (1), a sulfonamide group (2) or an active imide group (3) is particularly preferable. Such a polymer compound includes the following compounds, but the invention is not limited thereto.

Polymer compounds having a phenolic hydroxyl group (1) include, for example, novolak resins such as a phenol-formaldehyde resin, a m-cresol formaldehyde resin, a p-cresol-formaldehyde resin, m-/p-cresol formaldehyde resin, or a mixed formaldehyde resin of phenol/cresol (which may be any mixture of m-, p- or m-phenol/p-cresol), and pyrogallol acetone resin. As the polymer compound having a phenolic hydroxyl group, a polymer compound having a phenolic hydroxyl group in a side chain can also be preferably used. Polymer compounds having a phenolic hydroxyl group in a side chain include polymer compounds obtained by homopolymerizing a polymerizable monomer consisting of a low-molecular compound having one or more phenolic hydroxyl groups and are or more polymerizable unsaturated bonds, or by copolymerizing the monomer with another polymerizable monomer.

Polymerizable monomers having a phenolic hydroxyl group include acrylamide, methacrylamide, acrylate, methacrylate, and hydroxystyrene, each of which has a phenolic hydroxyl group. Specific examples of polymerizable monomers preferably used include N-(2-hydroxyphenyl)acrylamide, N-(3-hydroxyphenyl)acrylamide, N-(4-hydroxyphenyl)acrylamide, N-(2-hydroxyphenyl)methacrylamide, N-(3-hydroxyphenyl)methacrylamide, N-(4-hydroxyphenyl)methacrylamide, o-hydroxyphenyl acrylate, m-hydroxyphenyl acrylate, p-hydroxyphenyl acrylate, o-hydroxyphenyl methacrylate, m-hydroxyphenyl methacrylate, p-hydroxyphenyl methacrylate, o-hydroxystyrene, m-hydroxystyrene, p-hydroxystyrene, 2-(2-hydroxyphenyl)ethyl acrylate, 2-(3-hydroxyphenyl)ethyl acrylate, 2-(4-hydroxyphenyl)ethyl acrylate, 2-(2-hydroxyphenyl) ethyl methacrylate, 2-(3-hydroxyphenyl) ethyl methacrylate and 2-(4-hydroxyphenyl)ethyl methacrylate. Two or more resins having a phenolic hydroxyl group may be simultaneously used. C3 to C8 alkyl-substituted phenol/formaldehyde copolymers such as a t-butyl phenol formaldehyde resin and an octyl phenol formaldehyde resin, as described in U.S. Pat. No. 4,123,279, may be simultaneously used.

Alkali-soluble resins having a sulfonamide group (2) include polymer compounds obtained by homopolymerizing a polymerizable monomer having a sulfonamide group or by copolymerizing the monomer with another copolymerizable monomer. Polymerizable monomer having a sulfonamide group include a polymerizable monomer having, in a molecule, both at least one sulfonamide group (—NH—SO₂—) having at least one hydrogen atom bound to a nitrogen atom, and at least one unsaturated bond. In particular, a low-molecular compound having an acryloyl group, an allyl group or a vinyloxy group and a substituted or mono-substituted aminosulfonyl group or a substituted sulfonylimino group is preferable.

Alkali-soluble resins having an active imide group (3) are preferably ones having an active imide group in the molecule, and such a polymer compound is a polymer compound obtained by homopolymerizing a polymerizable monomer consisting of a low-molecular compound having in a molecule one or more active imide groups and one or more polymerizable unsaturated bonds, or by copolymerizing the monomer with another polymerizable monomer.

As such a compound, N-(p-toluenesulfonyl)methacrylamide, N-(p-toluenesulfonyl)acrylamide etc. can be preferably used.

Alkali-soluble resins having a carboxylic acid group (4) include, for example, a polymer having, as a main constitutional component, a minimum constitutional unit derived from a compound having in a molecule one or more carboxylic acid groups and one or more polymerizable unsaturated groups.

Alkali-soluble resins having a phosphoric acid group (5) include, for example, a polymer having, as a main constitutional component, a minimum constitutional element derived from a compound having in a molecule one or more phosphoric acid groups and one or more polymerizable unsaturated groups.

The alkali-soluble resin used in the upper layer in the invention is preferably a polymer compound produced by polymerizing two or more out of the polymerizable monomers having a phenolic hydroxyl group, the polymerizable monomer having a sulfonamide group, and the polymerizable monomer having an active imide group.

The copolymerizing ratio of the polymerizable monomers and combinations of polymerizable monomers are not limited, but in particular when the polymerizable monomer having a phenolic hydroxyl group is copolymerized with the polymerizable monomer having a sulfonamide group and/or the polymerizable monomer having an active imide group, the blending polymerizing ratio of these components is preferably within a range of 50:50 to 5:95, and particularly preferably within a range of 40:60 to 10:90.

The alkali-soluble resin used in the upper layer is preferably a polymer compound obtained by copolymerizing another polymerizable monomer in addition to one or more out of the polymerizable monomer having a phenolic hydroxyl group, the polymerizable monomer having a sulfonamide group and the polymerizable monomer having an active imide group. From the viewpoint of developability, the copolymerizing ratio in these circumstances is determined preferably such that the monomer conferring alkali solubility is contained in an amount of 10% by mole or more, and more preferably 20% by mole or more.

The other polymerizable monomer which can be used may include compounds shown in the following list (m1) to (m12), but the invention is not limited thereto.

(m1) Acrylates and methacrylates having an aliphatic hydroxyl group, such as, for example, 2-hydroxyethyl acrylate and 2-hydroxyethyl methacrylate.

(m2) Alkyl acrylates such as methyl acrylate, ethyl acrylate, propyl acrylate, butyl acrylate, amyl acrylate, hexyl acrylate, octyl acrylate, benzyl acrylate, 2-chloroethyl acrylate and glycidyl acrylate.

(m3) Alkyl methacrylates such as methyl methacrylate, ethyl methacrylate, propyl methacrylate, butyl methacrylate, amyl methacrylate, hexyl methacrylate, cyclohexyl methacrylate, benzyl methacrylate, 2-chloroethyl methacrylate and glycidyl methacrylate.

(m4) Acrylamide, methacylamide and derivatives thereof, such as N-methylol acrylamide, N-ethyl acrylamide, N-hexyl methacylamide, N-cylohexyl acrylamide, N-hydroxyethyl acrylamide, N-phenyl acrylamide, N-nitrophenyl acrylamide and N-ethyl-N-phenyl acrylamide.

(m5) Vinyl ethers such as ethyl vinyl ether, 2-chloroethyl vinyl ether, hydroxyethyl vinyl ether, propyl vinyl ether, butyl vinyl ether, octyl vinyl ether and phenyl vinyl ether.

(m6) Vinyl esters such as vinyl acetate, vinyl chloroacetate, vinyl butyrate and vinyl benzoate.

(m7) Styrene and derivatives thereof, such as α-methyl styrene, methyl styrene and chloromethyl styrene.

(m8) Vinyl ketones such as methyl vinyl ketone, ethyl vinyl ketone, propyl vinyl ketone and phenyl vinyl ketone.

(m9) Olefins such as ethylene, propylene, isobutylene, butadiene and isoprene.

(m10) N-vinyl pyrrolidone, acrylonitrile, methacrylonitrile etc.

(m11) Unsaturated imides such as maleimide, N-acryloyl acrylamide, N-acetyl methacrylamide, N-propionyl methacrylamide and N-(p-chlorobenzoyl) methacrylamide.

(m12) Unsaturated carboxylic acids such as acrylic acid, methacrylic acid, maleic anhydride and itaconic acid.

When the alkali-soluble polymer used in the upper layer in the invention is a homopolymer, or a copolymer of the polymerizable monomer having a phenolic hydroxyl group, of the polymerizable monomer having a sulfonamide group, or of the polymerizable monomer having an active imide group, the alkali-soluble polymer preferably has a weight average molecular weight of 2,000 or more, and a number average molecular weight of 500 or more. More preferably, the weight average molecular weight is 5,000 to 300,000, the number average molecular weight is 800 to 250,000, and the degree of dispersion (weight average molecular weight/number average molecular weight) is 1.1 to 10.

In particular, when the alkali-soluble resin used in the upper layer in the invention is phenol formaldehyde resin or cresol aldehyde resin, the weight average molecular weight is preferably 500 to 20,000, and the number average molecular weight is preferably 200 to 10,000.

From the viewpoints of inducing strong hydrogen bonding in a light-unexposed region and releasing a part of the hydrogen bonding in a light-exposed region the alkali-soluble resin used in the upper layer is preferably a resin having a phenolic hydroxyl group, and the resin having a phenolic hydroxyl group is particularly preferably a novolak resin.

Furthermore, in the invention, two or more kinds of alkali-soluble resins with different rates of dissolution in an aqueous alkaline solution may be used in a mixture, and the mixing ratio in these circumstance is arbitrary. The alkali-soluble resin preferably mixed with the resin having a phenolic hydroxyl group is, because of its low compatibility with the resin having a phenolic hydroxyl group, preferably an acryl resin, and more preferably an acryl resin having a sulfonamide group.

From the viewpoints of durability and sensitivity, etc. of the recording layer, in relation to the total solids content of the upper layer the content of the alkali-soluble resin is preferably 50 to 98% by mass.

(Infrared Absorbing Agents (B))

An infrared absorbing agent should be added to the lower layer and/or to the upper layer of the recording layer in the planographic printing plate precursor having the multi-layered recording layer in the invention. As the infrared absorbing agent, the same infrared absorbing agents as those usable in the single-layer recording layer can be used.

The infrared absorbing agent may be added to the lower layer or the upper layer, or to both the upper and lower layers, but from the viewpoint of sensitivity the infrared absorbing agent is preferably added to the upper layer of the recording layer, or to a layer near to the upper layer. In order to confer both high sensitivity and at the same time alkali resistant solubility in a light-unexposed region the infrared absorbing agent having a capacity to inhibit dissolution is particularly preferably added to the layer to which the alkali-soluble resin described above is added.

On the other hand, when the infrared absorbing agent is added to the lower layer, it becomes possible to achieve on even higher degree of sensitivity. When the infrared absorbing agent is added to both the upper and lower layers, the same compound may be used, or different compounds may be used.

Further, the infrared absorbing agent may be added to the upper and lower recording layers, or to a separately arranged layer. When the infrared absorbing agent is added to another layer, it is desirably added to a layer adjacent to the recording layer.

When the infrared absorbing agent is added to the upper layer, relative to the total solids content of the upper layer from viewpoints such as of sensitivity and durability (film properties) of the recording layer etc the agent can be added in an amount of 0.01 to 30% by mass, preferably 0.1 to 20% by mass, and more preferably 1.0 to 10% by mass.

When the infrared absorbing agent is added to the lower layer, relative to the total solids content of the lower layer it can be added in an amount of 0 to 20% by mass, preferably 0 to 10% by mass, and more preferably 0 to 5% by mass. When the infrared absorbing agent is added to the lower layer, use of a infrared absorbing layer having a capacity to inhibit dissolution leads to a reduction in the solubility of the lower layer, but on the other hand the infrared absorbing agent can generate heat upon exposure to an infrared laser light and thus improve the solubility of the lower layer by heat. Thus the kind of compound added and the amount of the compound added should both be selected after taking such a balance into consideration.

In a region of 0.2 to 0.3 μm in the vicinity of the support, heat generated upon exposure to light is diffused to the support so that it becomes difficult to reliably achieve an improvement in solubility by heat, and the diminition in solubility of the lower layer resulting from the addition of the infrared absorbing dye can on occasions lead to a reduction in sensitivity. Therefore, even when the amount of the infrared absorbing agent added is within the range defined above it is preferable that the infrared absorbing agent not be added by an amount that causes the rate of dissolution of the lower layer in a developer (25° C. to 30° C.) to drop below 30 nm/sec.

(Development Inhibitors (C))

A development inhibitor is preferably contained in the upper layer in the invention, for the purpose of enhancing inhibition (capacity to inhibit dissolution) of the layer. Particularly, when an infrared absorbing agent used does not have a capacity to inhibit dissolution, this development inhibitor can be an important factor in maintaining the alkali resistance of an image region.

The development inhibitor used in a multi-layered recording layer can be the same as development inhibitor (C) mentioned above as a component in the single-layer recording layer. For example, quaternary ammonium salts and polyethylene glycol compounds can also be preferably used. Among image-coloring agents described later, some compounds function also as a development inhibitor and can be mentioned as preferable examples.

As the quaternary ammonium salt, the same quaternary ammonium salts can be used mentioned as those above as the development inhibitor in the single-layer recording layer.

From the viewpoints of effectiveness in inhibiting development and at the same time enabling the alkali-soluble resin to form film satisfactorily, the amount of the quaternary ammonium salt added is preferably 0.1 to 50% by mass, and more preferably 1 to 30% by mass relative to the total solids content of the upper layer.

As the polyethylene glycol compound, the same polyethylene glycol compound can be used as that mentioned as the development inhibitor in the single-layer recording layer mentioned above.

From the viewpoints of effectiveness in inhibiting development and at the same time facilitating image formability, the amount of polyethylene glycol compound added is preferably 0.1 to 50% by mass, and more preferably 1 to 30% by mass relative to the total solids content of the upper layer.

A lactone compound is also effective in achieving the same effects as in the single-layer recording layer, and the same compounds as those mentioned in the description of the single-layer recording layer can also be used.

Among such lactone compounds, from the viewpoint of and ease in the adding process and the effects of image formability, the amount to be added of the compounds represented by formulae (L-I) and (L-II) which are particularly preferably used, relative to the total solids content of the upper layer, is preferably 0.1 to 50% by mass, and more preferably 1 to 30% by mass.

In addition, in order to enhance the inhibition of an image region in a developer thermally decomposable onium salts, o-quinone diazide compounds, aromatic sulfone compounds and aromatic sulfonates, in a non-decomposed state, are preferably used in combination with a substance reducing substantially the solubility of the alkali-soluble resin.

As the onium salt, the same onium salts can be used as those mentioned as the development inhibitor in the above single-layer recording layer mentioned above.

As the o-quinone diazide, the same o-quinone diazides can be used as those mentioned as the development inhibitor in the single-layer recording layer described above.

Relative to the total solids content of the upper layer, the amount of the o-quinone diazide compound added is within the range of preferably 1 to 50% by mass, more preferably 5 to 30% by mass, and still more preferably 10 to 30% by mass.

For the purpose of enhancing both inhibition of the surface of the recording layer and resistance to surface scratches, a polymer having, as a polymerizable monomer, a (meth)acrylate monomer with two or three C3 to C20 perfuloroalkyl groups in a molecule, as described in JP-A No. 2000-187318, is preferably simultaneously used.

Relative to the total solids content of the upper layer, the amount of polymer added is in the range of preferably 0.1 to 10% by mass, and more preferably 0.5 to 5% by mass.

(Other Additives)

In addition to the essential components described above, various additives can if necessary be added for formation of the lower layer and the upper layer of the polymerizable recording layer, as long as the effect of the invention are not diminished. The additives described below may be added to the lower layer only, to the upper layer only, or to both of the two layers.

<Development Accelerator>

For the purpose of enhancing sensitivity, a development accelerator may be added to the upper layer and/or to the lower layer in the recording layer in the invention. As the development accelerator, acid anhydrides, phenols and organic acids can be used, such as those mentioned as the development accelerator in the single-layer recording layer described above.

Relative to the total solids content of the lower or upper layer, the amount of acid anhydrides, phenols and organic acids is preferably 0.05 to 20% by mass, more preferably 0.1 to 15% by mass, and 1 more preferably 0.1 to 10% by mass.

<Surfactants>

For improving coating properties and stability in treatment under development conditions, a surfactant can be added to the upper layer and/or to the lower layer in the recording layer in the invention. As the surfactant, the nonionic surfactants and the amphoteric surfactants mentioned as surfactants in the single-layer recording layer described above can be used.

Relative to the total solids content of the lower or upper layer, the amount of the nonionic surfactants and amphoteric surfactant is preferably 0.01 to 15% by mass, more preferably 0.1 to 5.0% by mass, and still more preferably 0.5 to 2.0% by mass.

<Printing Agents/Colorants>

A printing agent for producing a visual image immediately after heating with exposure to light, and a dye or pigment as an image-coloring agent, can be added to the upper layer and/or to the lower layer in the recording layer in the invention.

The same printing agents or image-coloring agent can be used as those mentioned in the single-layer recording layer described above.

Relative to the total solids content of the lower or upper layer, these dyes can be added in an amount of 0.01 to 10% by mass, and more preferably 0.1 to 3% by mass.

<Plasticizers>

In order to endow a coating with flexibility etc a plasticizer may be added to the upper layer and/or to the lower layer in the recording layer in the invention. As the plasticizer, the same plasticizers can be used as those mentioned in connection with the above single-layer recording layer.

Relative to on the total solids content of the lower or upper layer, these plasticizers can be added in an amount of 0.5 to 10% by mass, and preferably 1.0 to 5% by mass.

<Waxing Agents>

For the purpose of conferring mar resistance, a compound that reduces the coefficient of static friction on the surface can be added to the upper layer in the invention. As such a compound, the same waxing agents can be used as those mentioned in the case of the single-layer recording layer described above. Relative to the upper layer, the amount of waxing agent added is preferably 0.1 to 10% by mass, and more preferably 0.5 to 5% by mass.

[Formation of the Recording Layer]

The recording layer (the single-layer recording layer, or the lower or upper layer of the multi-layered recording layer) in the planographic printing plate precursor of the invention can usually be formed by dissolving the above components in a solvent to form a recording layer coating solution and by then applying the solution onto a suitable support.

The solvent used therein includes, but is not limited to, ethylene dichloride, cyclohexanone, methyl ethyl ketone, methanol, ethanol, propanol, ethylene glycol monomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethylurea, N-methylpyrrolidone, dimethyl sulfoxide, sulfolane, γ-butyrolactone and toluene. These solvents can be used individually or in mixtures thereof.

Particularly in the multi-layered recording layer, it is generally preferable that the lower layer and the upper layer be formed with the layers separated from each other.

Methods of forming the two layers by separation include, for example, a method of utilizing a difference in solvent solubility between components contained in the lower layer and components contained in the upper layer; and a method which involves applying the upper layer and then rapidly drying and removing the solvent.

Hereinafter, these methods are described in detail, but the method of applying the two layers by separation is not limited thereto.

In the method of utilizing a difference in solvent solubility between the components contained in the lower layer and the components contained in the upper layer, a solvent system is used to apply the upper-layer coating solution wherein the components contained in the lower layer are in a category of insoluble. In this way, it is possible for the respective layers to be clearly separated and formed even when two layers are applied. For example, components that are insoluble in a solvent such as methyl ethyl ketone or 1-methoxy-2-propanol, in which the alkali-soluble resin forming the upper layer component is dissolved are selected as the lower-layer component, and the lower layer is applied by using a solvent system in which the lower-layer component is dissolved and then dried. Thereafter, the upper-layer component based on the alkali-soluble resin is dissolved in methyl ethyl ketone or 1-methoxy-2-propanol, then applied and dried to form the two layers.

Examples of the method of drying the solvent very rapidly after application of the second layer (upper layer) include a method wherein high-pressure air is sprayed through a slit nozzle arranged almost perpendicularly to the running direction of the web, and a method wherein heat energy in a roll (heating roll) supplied with a heating medium such as steam is given as conductive heat from the underside of the web, and a combination of the two method.

To confer new functions, the upper and lower layers may be positively rendered partially compatible with each other as long as the effects of the invention are sufficiently demonstrated. This can be achieved by regulating the degrees to which the method of utilizing a difference in solvent solubility, and the method of drying the solvent very rapidly after application of the second layer are used.

In the recording layer coating solution applied onto a support, the concentration of the components described above (total solids content including additives) excluding the solvent is preferably 1 to 50% by mass.

For coating, various methods can be used, and for example, bar coater coating, rotational coating, spray coating, curtain coating, dip coating, air knife coating, blade coating and roll coating can be mentioned.

In particular, when the upper layer in a multi-layered recording layer is applied, in order to prevent damage to the lower layer the method of applying the upper layer is desirably a form of non-contact. In a contact-type method used generally in coating with a solvent, bar coater coating can also be used, but to prevent damage to the lower layer coating is preferably conducted in regular rotation.

From viewpoints such as sensitivity and printing durability, the amount of recording-layer components in the single-layer recording layer after drying is preferably within a range of 0.7 to 4.0 g/m², and more preferably within a range of 0.8 to 3.0 g/m².

From viewpoints such as sensitivity and printing durability, the amount of the lower-layer components in the multi-layered recording layer after drying is preferably within a range of 0.5 to 4.0 g/m², and more preferably within a range of 0.6 to 2.5 g/m².

From viewpoints such as sensitivity, development latitude and mar resistance, the amount of upper-layer components after drying is preferably within a range of 0.05 to 1.0 g/m², and more preferably within a range of 0.08 to 0.7 g/m².

From viewpoints such as sensitivity, image reproducibility and printing durability, the total coating amount of the lower and upper layers after drying is preferably within a range of 0.6 to 4.0 g/m², and more preferably within a range of 0.7 to 2.5 g/m².

[Supports]

The support used in the planographic printing plate precursor of the invention is not particularly limited, as long as it is a dimensionally stable plate having the necessary strength and durability. Examples include paper, paper laminated with plastics (e.g., polyethylene, polypropylene, polystyrene etc.), a metal plate (e.g., aluminum, zinc, copper etc.), a plastic film (e.g., cellulose diacetate, cellulose triacetate, cellulose propionate, cellulose butyrate, cellulose butyrate acetate, cellulose nitrate, polyethylene terephthalate, polyethylene, polystyrene, polypropylene, polycarbonate, polyvinyl acetal etc.), and papers or plastic films having these metals laminated or vapor-deposited thereon.

In particular, the support is preferably a polyester film or an aluminum plate, of which the aluminum plate is excellent in terms of dimensional stability, is also relatively inexpensive and is thus particularly preferable. The aluminum plate is preferably a pure aluminum plate, or an alloy plate based on aluminum containing a very small amount of different elements, or a plastic film having aluminum laminated or vapor-deposited thereon. The different elements contained in the aluminum alloy include silicon, iron, manganese, copper, magnesium, chromium, zinc, bismuth, nickel, and titanium. The content of the different elements in the alloy is up to 10% by mass in total.

Particularly preferable aluminum in the invention is pure aluminum, but because production of absolutely pure aluminum is difficult in terms of refining techniques, aluminum used may contain a very small amount of different elements.

The composition of the aluminum plate thus used in the invention is not limited, and any aluminum plates made of a known and conventionally used aluminum material can be used as appropriate. The thickness of the aluminum plate used in the invention is in the order of 0.1 to 0.6 mm, and preferably 0.15 to 0.4 mm, particularly preferably 0.2 to 0.3 mm.

The aluminum plate may if necessary be subjected to surface treatment such as surface roughening treatment or anodizing treatment. Hereinafter, such surface treatment is briefly described.

Before the surface is roughened, in order to remove rolling oil on the surface degreasing treatment with for example a surfactant, an organic solvent or an aqueous alkali solution is as necessary conducted. The treatment of roughening the surface of the aluminum plate is conducted by various methods, for example a method of mechanical surface roughening, a method of surface roughening by electrochemical dissolution and a method of chemically and selectively dissolving the surface.

The mechanical method can make use of known techniques such as ball grinding, brush grinding, blast grinding and buff grinding. The electrochemical roughening method includes a method of roughening the surface in a hydrochloric acid or a nitric acid electrolyte by use of alternating current or a direct current. Further, a combination of both methods can also be utilized, as disclosed in JP-A No. 54-63902.

After the aluminum plate thus surface-roughened is subjected as necessary to alkali etching treatment and neutralization treatment, in order to improve the water holding property and abrasion resistance of the surface the plate can be subjected to anodizing treatment. The electrolyte for use in the anodizing treatment of the aluminum plate can be various electrolytes for forming a porous oxide film, and generally sulfuric acid, phosphoric acid, oxalic acid, chromic acid or a mixed acid thereof is used. The concentration of the electrolyte is appropriately, depending on the type of electrolyte.

Conditions for the anodizing treatment can vary, depending on the electrolyte used, and cannot be generalized, but usually it is preferable that the concentration of the electrolyte be 1 to 80% by mass, the liquid temperature be 5 to 70° C., the current density be 5 to 60 A/dm², the voltage be 1 to 100 V, and the electrolysis time be within a range of 10 seconds to 5 minutes. If the amount of anodized film is less than 1.0 g/m², printing durability is inadequate, the non-image region in the planographic printing plate is easily scratched and a so-called “tinting due to scratch” tends to occur. This is caused by ink adhering to scratched regions at the time of printing.

After completion of the anodizing treatment, the surface of the aluminum plate is subjected to hydrophilization treatment.

The hydrophilization treatment used in the invention includes an alkali metal silicate (e.g., a sodium silicate aqueous solution) method disclosed in U.S. Pat. Nos. 2,714,066, 3,181,461, 3,280,734 and 3,902,734. In this method, the support is dipped in an aqueous solution of sodium silicate, or electrolyzed. Alternatively, a method of treatment with potassium fluorozirconate is used, as disclosed in JP-B No. 36-22063, or a method of treatment with polyvinyl phosphonic acid, as disclosed in U.S. Pat. Nos. 3,276,868, 4,153,461, and 4,689,272.

(Undercoat Layer)

The planographic printing plate precursor in the invention can if necessary be provided with an undercoat layer between the support and the recording layer.

As the component used in the undercoat layer, there are used various organic compounds can be used which can be selected from, for example, carboxymethyl cellulose; dextrin; gum arabic; amino-containing phosphonic acids such as 2-aminoethylphosphonic acid, organic phosphonic acids such as optionally substituted phenylphosphonic acid, naphthylphosphonic acid, alkylphosphonic acid, glycerophosphonic acid, methylene diphosphonic acid and ethylene diphosphonic acid; organic phosphoric acids such as optionally substituted phenylphosphoric acid, naphthylphosphoric acid, alkylphosphoric acid and glycerophosphoric acid, organic phosphinic acid such as optionally substituted phenylphosphinic acid, naphthylphosphinic acid, alkylphosphinic acid and glycerophosphinic acid; amino acids such as glycine and β-alanine; and hydroxyl-containing amine hydrochloride such as triethanolamine hydrochloride. Mixtures of two or more of these organic compounds can also be used.

Preferably, the undercoat layer also contains a compound having an onium group. Compound having an onium group are described in detail in JP-A Nos. 2000-10292 and 2000-108538. In addition, a compound selected from a group of polymer compounds having a structural unit represented by poly(p-vinyl benzoic acid) in a molecule can also be used. Specifically, these polymer compounds include a p-vinyl benzoic acid/vinyl benzyl triethyl ammonium salt copolymer and a p-vinyl benzoic acid/vinyl benzyl trimethyl ammonium chloride copolymer.

The organic undercoat layer can be provided by the following methods: a method of providing an organic undercoat layer by applying a solution containing the organic compound dissolved in water, or an organic solvent such as methanol, ethanol and methyl ethyl ketone, or a mixed solvent thereof, onto an aluminum plate and then drying the solution; or a method of providing an organic undercoat layer by dipping an aluminum plate in a solution containing the organic compound dissolved in water, or an organic solvent such as methanol, ethanol and methyl ethyl ketone or a mixed solvent thereof, to adsorb the organic compound onto the aluminum plate, and then washing and drying thereof. In the former method, the solution containing the organic compound at a concentration of 0.005 to 10% by mass can be applied by various methods. In the latter method, the concentration of the organic compound in the solution is 0.01 to 20% by mass, and preferably 0.05 to 5% by mass, the dipping temperature is 20 to 90° C., preferably 25 to 50° C., and the dipping time is 0.1 second to 20 minutes, preferably 2 seconds to 1 minute. The solution can also be regulated within a range of pH 1 to 12 with a basic material such as ammonia, triethylamine and potassium hydroxide, or an acidic material such as hydrochloric acid and phosphoric acid. A yellow dye can also be added for the purpose of regeneration of tone in the image-recording material.

From the viewpoint of printing durability, the coating amount of the organic undercoat layer is preferably 2 to 200 mg/m², and more preferably 5 to 100 mg/m².

The planographic printing plate precursor prepared in the manner described above is subjected to image-like light exposure and then subjected to development treatment.

(Back Coat Layer)

The planographic printing plate precursor of the invention is as necessary provided with a back coat layer on the back of the support. The back coat is preferably a coating layer consisting of metal oxides, obtained by hydrolysis and polycondensation of organic polymer compounds, as described in JP-A No. 5-45885, or alternatively, organic or inorganic metal compounds, as described in JP-A No. 6-35174. Among these coating layers, coating layers of metal oxides obtained from alkoxy silicon compounds such as Si(OCH₃)₄, Si(OC₂H₅)₄, Si(OC₃H₇)₄ and Si(OC₄H₉)₄ are particularly preferable because these materials are readily and inexpensively availabl, and coating layers of metal oxides obtained therefrom are excellent in terms of resistance to a developer.

[Light Exposure]

The light source of actinic rays used in image-like light exposure of the planographic printing plate precursor in the invention is preferably a light source having emission wavelengths in the near infrared to infrared regions. A solid laser and semiconductor laser are particularly preferable.

[Development Treatment]

The developer which can be used in the development treatment of the planographic printing plate precursor of the invention is a developer having a pH value within a range of 9.0 to 14.0, and preferably within a range of 12.0 to 13.5. As the developer and its replenishing solution (hereinafter referred to collectively as the developer), an aqueous alkali solutions known in the art can be used.

Examples include inorganic alkali salts such as sodium silicate, potassium silicate, tribasic sodium phosphate, tribasic potassium phosphate, tribasic ammonium phosphate, dibasic sodium phosphate, dibasic potassium phosphate, dibasic ammonium phosphate, sodium carbonate, potassium carbonate, ammonium carbonate, sodium hydrogen carbonate, potassium hydrogen carbonate, ammonium hydrogen carbonate, sodium borate, potassium borate, ammonium borate, sodium hydroxide, ammonium hydroxide, potassium hydroxide and lithium hydroxide. Other examples include organic alkalis such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethylene imine, ethylene diamine, and pyridine.

These alkalis can be used individually or in combinations thereof.

Among aqueous solutions of alkalis described above, one developer demonstrating the effects of the invention is an aqueous solution having a pH value of 12 or more. This is called a “silicate developer”, and contains as a base an alkali silicate or an alkali silicate having a silicon compound mixed with a base. Another preferable developer is an alkali silicate-free “non-silicate developer” containing a non-reducing sugar (organic compound having a buffering action) and a base.

In the former developer, the developability of an aqueous solution of the alkali metal silicate can be regulated by, components in the silicate a ratio of the silicon oxide SiO₂ to the alkali metal oxide M₂O (generally expressed as the molar ratio of [SiO₂]/[M₂O]) and by the concentration of the two components. Preferably used aqueous solutions include, as disclosed in JP-A No. 54-62004, an aqueous solution of sodium silicate containing SiO₂ in an amount of 1 to 4% by mass, wherein the molar ratio of SiO₂/Na₂O is 1.0 to 1.5 (that is, [SiO₂]/[Na₂O] is 1.0 to 1.5); and as disclosed in JP-B No. 57-7427an aqueous solution of an alkali metal silicate containing SiO₂ at a concentration of 1 to 4% by mass and potassium in an amount of at least 20%, relative to the gram atoms of all alkali metals present in the developer, wherein the molar ratio of SiO₂/[M] is 0.5 to 0.75 (that is, [SiO₂]/[M₂O] is 1.0 to 1.5).

The alkali silicate-free “non-silicate developer” containing a non-reducing sugar and a base is also preferably applied to the development of the planographic printing plate precursor of the invention. By development treatment of the planographic printing plate precursor with this developer, the inking property of the recording layer can be maintained in a superior state without the surface of the recording layer being damaged.

The developer is preferably a solution within a range of pH 9.0 to 13.5 whose main component is composed of at least one compound selected from non-reducing sugars and at least one type of base.

Such non-reducing sugar is a sugar free of an aldehyde group and a ketone group and does not display reducing properties. The non-reducing sugar is classified into trehalose-type oligosaccharide having reducing groups bound to one another, glycoside having a sugar reducing group bound to a non-sugar, and sugar alcohol having a hydrogenated and reduced sugar, and all these can be preferably used.

The trehalose-type oligosaccharide includes saccharose and trehalose, and the glycoside includes alkyl glycosides, phenol glycosides, and mustard oil glycosides etc. The sugar alcohol includes D,L-arabitol, ribitol, xylitol, D,L-sorbitol, D,L-mannitol, D,L-iditol, D,L-talitol, dulcitol and allodulcitol.

A reducing body (reducing starch syrup) obtained by hydrogenating maltitol and oligosaccharides obtained by hydrogenating disaccharides is preferably used.

Among these, particularly preferable non-reducing sugars include sugar alcohol and saccharose, and in particular D-sorbitol, saccharose and reducing starch syrup are preferable because they are inexpensive and have a buffering action in a suitable pH range.

These non-reducing sugars can be used individually or in combinations of two or more thereof, and from the viewpoint of the effects of buffering action and developability the content thereof in the developer is preferably 0.1 to 30% by mass, and more preferably 1 to 20% by mass,.

As the base combined with the non-reducing sugar, a known alkali can be used. Examples include inorganic alkalis such as sodium hydroxide, potassium hydroxide, lithium hydroxide, trisodium phosphate, tripotassium phosphate, triammonium phosphate, disodium phosphate, dipotassium phosphate, diammonium phosphate, sodium carbonate, potassium carbonate, ammonium carbonate, sodium hydrogen carbonate, potassium hydrogen carbonate, ammonium hydrogen carbonate, sodium borate, potassium borate and ammonium borate. Use can also be made of organic alkalis such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, monoisopropanolamine, diisopropanolamine, ethylene imine, ethylene diamine, and pyridine.

These alkalis can be used individually or in combinations of two or more thereof. Preferable among these are sodium hydroxide and potassium hydroxide, because the pH can be regulated in a broader pH range by regulating the ratio thereof to the non-reducing sugar. Further, trisodium phosphate, tripotassium phosphate, sodium carbonate and potassium carbonate are also preferable because of their buffering action.

These alkalis are added so as to regulate the pH of the developer within a range of 9.0 to 13.5, and the amount of alkalis added is determined on the basis of the pH desired and the type and amount of non-reducing sugar added. The pH range is more preferably 10.0 to 13.2.

In the developer, an alkaline buffer solution comprising a weak acid other than sugar and a strong base can be simultaneously used. The weak acid used in the buffer solution is preferably one having a dissociation constant (pKa) of 10.0 to 13.2.

The weak acid is selected from those described in IONISATION CONSTANTS OF ORGANIC ACIDS IN AQUEOUS SOLUTION published by Pergamon Press. Examples include alcohols such as 2,2,3,3-tetrahydropropanol-1 (pKa 12.74), trifluoroethanol (pKa 12.37), and trichloroethanol (pKa 12.24) etc.; aldehydes such as pyridine-2-aldehyde (pKa 12.68) and pyridine-4-aldehyde (pKa 12.05) etc.; compounds having a phenolic hydroxyl group such as salicylic acid (pKa 13.0), 3-hydroxy-2-naphthoic acid (pKa 12.84), catechol (pKa 12.6), gallic acid (pKa 12.4), sulfosalicylic acid (pKa 11,7), 3,4-dihydrosulfonic acid (pKa 12.2), 3,4-dihydroxybenzoic acid (pKa 11.94), 1,2,4-trihydroxybenzene (pKa 11.82), hydroquinone (pKa 11.56), pyrogallol (pKa 11.34), o-cresol (pKa 10.33), resorcinol (pKa 11.27), p-cresol (pKa 10.27), and m-cresol (pKa 10.09); oximes such as 2-butanone oxime (pKa 12.45), acetoxime (pKa 12.42), 1,2-cycloheptane dione dioxime (pKa 12.3), 2-hydroxybenzaldehyde oxime (pKa 12.10), dimethyl glyoxime (pKa 11.9), ethane diamide dioxime (pKa 11.37) and acetophenone oxime (pKa 11.35); and nucleic acid-related substances such as adenosine (pKa 12.56), inosine (pKa 12.5), guanine (pKa 12.3), cytosine (pKa 12.2), hypoxanthine (pKa 12.1) and xanthine (pKa 11.9); and weak acids such as diethylaminomethylphosphonic acid (pKa 12.32), 1-amino-3,3,3-trifluorobenzoic acid (pKa 12.29), isopropylidenedisulfonic acid (pKa 12.10), 1,1 -ethylidenediphosphonic acid (pKa 11.54), 1-hydroxy 1,1-ethylidenediphosphonate (pKa 11.52), benzimidazole (pKa 12.86), thiobenzamide (pKa 12.8), picoline thioamide (pKa 12.55) and barbituric acid (pKa 12.5).

Among these weak acids, sulfosalicylic acid and salicylic acid are preferable. As the base to be combined with these weak acids, sodium hydroxide, ammonium hydroxide, potassium hydroxide, and lithium hydroxide are preferably used. These alkalis are used individually or in combinations of two or more thereof. These various alkalis are used within a preferable pH range by regulating concentrations and combinations thereof.

For the purpose of promoting developability, dispersing development scum and improving affinity to ink of an image region on the printing plate, various surfactants and organic solvents can if necessary be added. Preferable surfactants include anionic, cationic, nonionic and amphoteric surfactants.

Preferable examples of the surfactant include nonionic surfactants such as polyoxyethylene alkyl ethers, polyoxyethylene alkyl phenyl ethers, polyoxyethylene polystyryl phenyl ethers, polyoxyethylene polyoxypropylene alkyl ethers, glycerin fatty partial esters, sorbitan fatty partial esters, pentaerythritol fatty partial esters, propylene glycol monofatty esters, sucrose fatty partial esters, polyoxyethylene sorbitan fatty partial esters, polyoxyethylene sorbitol fatty partial esters, polyethylene glycol fatty esters, polyglycerin fatty partial esters, polyoxyethylene castor oil, polyoxyethylene glycerin fatty partial esters, fatty acid diethanol amides, N,N-bis-2-hydroxyalkyl amines, polyoxyethylene alkyl amine, triethanol amine fatty ester and trialkyl amine oxide; anionic surfactants such as aliphatic acid salts, abietates, hydroxyalkane sulfonates, alkane sulfonates, dialkylsulfosuccinates, linear alkyl benzene sulfonates, branched alkyl benzene sulfonates, alkyl naphthalene sulfonates, alkyl phenoxy polyoxyethylene propyl sulfonates, polyoxyethylene alkyl sulfophenyl ether salts, N-methyl-N-oleyl taurine sodium salt, N-alkyl sulfosuccinic monoamide disodium salt, petroleum sulfonates, sulfuric tallow oil, fatty alkyl ester sulfates, alkyl sulfates, polyoxyethylene alkyl ether sulfates, fatty monoglyceride sulfates, polyoxyethylene alkyl phenyl ether sulfates, polyoxyethylene styryl phenyl ether sulfates, alkyl phosphates, polyoxyethylene alkyl ether phosphates, polyoxyethylene alkyl phenyl ether phosphates, partially saponified styrene/maleic anhydride copolymers, partially saponified olefin/maleic anhydride copolymers and naphthalene sulfonate formalin condensates etc.; cationic surfactants such as alkyl amine salts, quaternary ammonium salts of tetrabutyl ammonium bromides etc., polyoxyethylene alkyl amine salts and polyethylene polyamine derivatives etc.; and amphoteric surfactants such as carboxy betaines, aminocarboxylic acids, sulfobetaines, aminosulfates and imidazolines. Polyoxyethylene in the surfactants described above can be deemed to be polyoxyalkylene such as polyoxymethylene, polyoxypropylene, polyoxybutylene etc., and their surfactants are also included.

Further preferable surfactants are fluorine-based surfactants containing a perfluoroalkyl group in a molecule. Such fluorine-based surfactants include anionic surfactants such as perfluoroalkyl carboxylates, perfluoroalkyl sulfonates and perfluoroalkyl phosphates, amphoteric surfactants such as perfluoroalkyl betaine, cationic surfactants such as perfluoroalkyl trimethyl ammonium salts, and nonionic surfactants such as perfluoroalkyl amine oxide, perfluoroalkyl ethylene oxide adducts, perfluoroalkyl group- and hydrophilic group-containing oligomers, perfluoroalkyl group- and lipophilic group-containing oligomers, perfluoroalkyl group-, hydrophilic group- and lipophilic group-containing oligomers, and perfluoroalkyl group- and lipophilic group-containing urethane.

The surfactants can be used individually or in combinations of two or more thereof, and they are added into the developer within a range of 0.001 to 10% by mass, or more preferably 0.01 to 5% by mass.

In the developer, various development stabilizers can be used. Preferable examples include those described in JP-A No. 6-282079, such as sugar alcohol/polyethylene glycol adducts; tetraalkyl ammonium salts such as tetrabutyl ammonium hydroxide; phosphonium salts such as tetrabutyl phosphonium bromide; and iodonium salts such as diphenyl iodonium chloride.

Furthermore, mention can also be made of anionic surfactants or amphoteric surfactants described in JP-A No. 50-51324, water-soluble cationic polymers described in JP-A No. 55-95946, and water-soluble amphoteric polymeric electrolytes described in JP-A No. 56-142528.

Mention can also be made of alkylene glycol-added organoboron compounds described in JP-A No. 59-84241, water-soluble surfactants, such as polyoxyethylene/polyoxypropylene block polymers, described in JP-A No. 60-111246, polyoxyethylene/polyoxypropylene-substituted alkylene diamine compounds disclosed in JP-A No. 60-129750, polyethylene glycols having a weight average molecular weight of 300 or more, as described in JP-A No. 61-215554, fluorine-containing surfactants having a cationic group in JP-A No. 63-175858, and water-soluble ethylene oxide-added compounds, and water-soluble polyalkylene compounds, obtained by adding 4 moles or more of ethylene oxide to an acid or alcohol, as disclosed in JP-A No. 2-39157.

If necessary, an organic solvent can be added to the developer. The organic solvent is preferably one having a water solubility of about 10% by mass or less, and more preferably 5% by mass or less. Examples of such organic solvents include 1-phenyl ethanol, 2-phenyl ethanol, 3-phenyl-1-propanol, 4-phenyl-1-butanol, 4-phenyl-2-butanol, 2-phenyl-1-butanol, 2-phenoxy ethanol, 2-benzyloxy ethanol, o-methoxy benzyl alcohol, m-methoxy benzyl alcohol, p-methoxy benzyl alcohol, benzyl alcohol, cyclohexanol, 2-methyl cyclohexanol, 3-methyl cyclohexanol, 4-methyl cyclohexanol, N-phenyl ethanol amine and N-phenyl diethanol amine.

The content of the organic solvent is preferably 0.1 to 5% by mass relative to the total weight of the solution used. The amount of organic solvent added is related closely to the amount of the surfactant used, and as the amount of organic solvent is increased, the amount of surfactant is preferably increased. The reason for this is that if a large amount of organic solvent is used in the presence of a small amount of surfactant, the organic solvent is not completely dissolved, and thus cannot be expected to secure good development.

In order to prevent tinting on the printing plate a reducing agent may further be added to the developer. Preferable organic reducing agents include phenol compounds such as thiosalicylic acid, hydroquinone, methol, methoxyquinone, resorcin and 2-methyl resorcin; and amine compounds such as phenylene diamine and phenyl hydrazine. Other preferable inorganic reducing agents include sodium salts, potassium salts and ammonium salts of inorganic acids such as sulfurous acid, hydrogensulfurous acid, phosphorous acid, hydrogenphosphorous acid, dihydrogenphosphorous acid, thiosulfuric acid and dithionous acid.

Among these reducing agents, sulfurous acid is particularly excellent in terms of preventing tinting. The amount of reducing agent used in the developer is contained within a range of 0.05 to 5% by mass.

An organic carboxylic acid can also be added to the developer. The organic carboxylic acid is preferably an aliphatic or aromatic carboxylic acid having 6 to 20 carbon atoms. Examples of the aliphatic acid include, caproic acid, enanthic acid, capric acid, lauric acid, myristic acid, palmitic acid, and stearic acid, and particularly preferably an alkanoic acid having 8 to 12 carbon atoms. The organic carboxylic acid may also be an unsaturated fatty acid having a carbon-carbon double bond in its carbon chain, or a fatty acid having a branched carbon chain.

The aromatic carboxylic acids are compounds having a benzene ring, a naphthalene ring or an anthracene ring substituted with a carboxyl group. Specific examples include o-chlorobenzoic acid, p-chlorobenzoic acid, o-hydroxybenzoic acid, p-hydroxybenzoic acid, o-aminobenzoic acid, p-aminobenzoic acid, 2,4-dihydroxybenzoic acid, 2,5-dihydroxybenzoic acid, 2,6-dihydroxybenzoic acid, 2,3-dihydroxybenzoic acid, 3,5-dihydroxybenzoic acid, gallic acid, 1-hydroxy-2-naphthoic acid, 3-hydroxy-2-naphthoic acid, 2-hydroxy-1-naphthoic acid, 1-naphthoic acid and 2-naphthoic acid, and among them hydroxynaphthoic acid is particularly effective.

In order to increase water solubility the aliphatic and aromatic carboxylic acids described above are preferably used as sodium salts, potassium salts or ammonium salts thereof. The content of the organic carboxylic acid in the developer used in the invention is not particularly limited, but when the content is lower than 0.1% by mass, the effects are inadequate, while when the content is higher than 10% by mass, no further improvement in effects can be expected, and when other additives are simultaneously used, they can be prevented from being dissolved. Accordingly, in relation to the developer used the amount added is preferably 0.1 to 10% by mass, and more preferably 0.5 to 4% by mass,.

The developer can, as and when necessary, also contain a preservative, a colorant, a thickener, a deforming agent and a hard water-softening agent. The hard water-softening agent includes, for example, polyphosphoric acid and sodium salts, potassium salts and ammonium salts thereof; aminopolycarboxylic acids such as ethylenediaminetetraacetic acid, diethylenetriaminepentaacetic acid, triethylenetetraminehexaacetic acid, hydroxyethylenediaminetriacetic acid, nitrilotriacetic acid, 1,2-diaminocyclohexanetetraacetic acid and 1,3-diamino-2-propanol tetraacetic acid, sodium salts, potassium salts and ammonium salts thereof; aminotri(methylene phosphonic acid), ethylene diamine tetra(methylene phosphonic acid), diethylene triamine penta(methylene phosphonic acid), triethylene tetramine hexa(methylene phosphonic acid), hydroxyethyl ethylene diamine tri(methylene phosphonic acid) and 1-hydroxyethane-1,1-diphosphonic acid, and sodium salts, potassium salts and ammonium salts thereof.

The optimum amount of hard water-softening agent varies, depending on chelation and the hardness and amount of hard water used. However, relative to developer used the hard water-softening agent is generally contained within a range of 0.01 to 5% by mass, and more preferably 0.01 to 0.5% by mass. When the amount of hard water-softening agent added is lower than within this range, the desired object cannot be adequately achieved, while when the amount is higher than within this range, adverse effects tend to occurs such as failure to color an image region.

The remaining part of the components in the developer is water. It is advantageous from the point of view of transportation that the developer be prepared as a concentrate with less water content than at the time used, and that the concentrate is diluted just before use. Each component in the concentrate is preferably set at a level which will not lead to the occurrence of separation or precipitation.

As the developer used in the invention, a developer described in JP-A No. 6-282079 can also be used. This developer contains a water-soluble ethylene oxide adduct obtained by adding 5 or more moles of ethylene oxide to sugar alcohol having 4 or more hydroxyl groups, and an alkali metal silicate having a molar ratio of SiO₂/M₂O [M being an alkali metal] in a range of 0.5 to 2.0.

The sugar alcohol is a polyvalent alcohol wherein an aldehyde group and a ketone group of the sugar are reduced to form the corresponding primary and secondary alcohol groups. Examples of the sugar alcohol include DL-threitol, erythritol, D,L-arabitol, ribitol, xylitol, D,L-sorbitol, D,L-mannitol, D,L-iditol, D,L-talitol, dulcitol and allodulcitol, and further examples include di-, tri-, tetra-, penta- and hexa-glycerin having sugar alcohol condensed therein.

The water-soluble ethylene oxide adduct is obtained by adding 5 or more moles of ethylene oxide to 1 mole of sugar alcohol. The ethylene oxide adduct may as and when necessary be further block-copolymerized, to a degree that the solubility of the propylene oxide is not impeded. The ethylene oxide adducts may be used individually or in combinations of two or more.

Relative to the developer (at the time of use), the amount of water-soluble ethylene oxide adduct added is preferably 0.001 to 5% by mass, and more preferably 0.001 to 2% by mass.

For the purpose of promoting developability, dispersing development scum and enhancing affinity for ink of an image region on the printing plate, the surfactants and organic solvents mentioned above can be added as and when necessary.

The planographic printing plate precursor subjected to development treatment with the developer having the above composition is post-treated with washing water, a surfactant-containing rinse, a fisher based on gum arabic and starch derivatives, or a protecting gum solution. These treatments can be appropriately used in combinations as the post-treatment of the planographic printing plate precursor of the invention.

In the industrial fields of plate-making and printing, an automatic developing machine for a photosensitive plate has been widely used in recent years for purpose of rationalization and standardization in the operation of plate-making. This automatic developing machine is in general terms made up of a developing part, a post-treatment part, a device for transferring a photosensitive plate, and a treating solution bath, and spraying device for each of these processes. While a photosensitive plate after light exposure is transferred horizontally, each treatment solution drawn by a pump is sprayed onto the photosensitive plate through a spray nozzle for development and post-development.

Other known methods include a method of development treatment by means of a dipping treatment of a photosensitive plate in a treatment solution bath filled with a treating solution while transferring it by use of guide rolls positioned in the solution, and a method wherein the surface of a printing plate after development is supplied with a predetermined small amount of washing water and washed, and the resulting waste water is then reused as water for diluting a stock solution of the developer.

Such automatic treatment can be further refined by supplementing each treatment solution with a replenishing solution, based on factors such as the degree of throughput and operating times. Further, a substantially untested treatment solution can also be applied, a treatment system known as “the throwaway treatment system”.

If an unnecessary image part (e.g., a trace of an edge of an original-picture film) occurs on the planographic printing plate obtained by image-like light exposure, by development, by washing with water and/or rinsing and/or gumming, the unnecessary image part can be eliminated.

For purposes of such elimination, a method of applying an eliminating solution onto the unnecessary image part, then leaving it for a predetermined time and washing it with water, as described in e.g. JP-B No. 2-13293, is preferable. However, a method can also be utilized of irradiating the unnecessary image part with actinic rays guided by an optical fiber followed by development, as described in JP-A No. 59-174842,.

The planographic printing plate of the invention thus obtained is as necessary coated with a desensitizing gum and then subjected to printing. For the purpose of further improving printing durability, the plampgraphic printing plate can also be subjected to baking treatment.

When the planographic printing plate is subjected to baking treatment, before baking the plate is preferably treated with an affinitizing solution, as described in JP-B Nos. 61-2518, 55-28062, JP-A Nos. 62-31859 and 61-159655.

This treatment can be carried out by applying onto the planographic printing plate a sponge or adsorbent cotton soaked in the affinitizing solution, by dipping the printing plate into a vat filled with the affinitizing solution, or by coating with an automatic coater. After coating, the affinitizing solution is preferably made uniform, by a means of squeezer, or with squeeze rollers.

The amount of affinitizing solution applied is preferably 0.03 to 0.8 g/m² (dry weight). The planographic printing plate coated with the affinitizing solution is as and when necessary dried and then heated at a high temperatures by means of a baking processor (e.g. BP-1300 available from Fuji Photo Film Co., Ltd.). The heating temperature and time required vary, depending on the type of components forming the image, but are preferably within the 180 to 300° C., and 1 to 20 minutes, respectively.

After baking treatment, the planographic printing plate can as necessary be subjected to conventional treatments such as washing with water and gumming. However, when an affinitizing solution containing water-soluble polymers etc. is used, the so-called desensitizing treatment such as gumming can be omitted. The planographic printing plate obtained by this treatment is loaded onto an offset printing machine etc. and used for printing on a large number of papers.

### EXAMPLES

Hereinafter, the present invention is described by reference to the Examples, but the invention is not limited to the Examples.

### Examples 1 to 6

[Preparation of a Support]

<Aluminum Plate>

An aluminum alloy containing 0.06% by mass Si, 0.30% by mass Fe, 0.025% by mass Cu, 0.001% by mass Mn, 0.001% by mass Mg, 0.001% by mass Zn and 0.03% by mass Ti, the balance being Al and inevitable impurities, was used to prepare a melt. The melt was then subjected to cleaning treatment, filtered and then formed by means of a DC casting method into an ingot of 500 mm in thickness and 1200 mm in width. After a surface layer of 10 mm in average thickness was shaved with a surface shaving machine, the ingot was kept at 550° C. for about 5 hours, and when the temperature was reduced to 400° C., the ingot was formed with a hot rolling mill into a rolled plate of 2.7 mm in thickness. Then, the plate was subjected to heat treatment at 500° C. with a continuous annealing device, finished with cold rolling to produce a plate of 0.24 mm in thickness, and an aluminum plate of JIS 1050 material was thus obtained.

The minor axis of the average crystalline particle diameter of the resulting aluminum was 50 μm, and the major axis was 300 μm. This aluminum plate was formed into a plate of 1030 mm in width and then subjected to the following surface treatment.

<Surface Treatment>

For the surface treatment, the following treatments (a) to (k) were conducted in success on. After each treatment and water washing, any liquid remaining was removed with nip rollers.

(a) Mechanical Surface Roughening Treatment

While being supplied with, as an abrasive slurry, an aqueous suspension of an abrasive (Pamis) having a specific gravity of 1.12 the surface of the aluminum plate was subjected to mechanical surface roughening treatment with a rotating roller-shaped nylon brush. The average particle diameter of the abrasive was 30 μm, and the maximum particle diameter was 100 μm. The nylon brush was made of 6 10 nylon, the length of the brush hair was 45 mm, and the diameter of the brush hair was 0.3 mm. The nylon brush had hairs arranged densely in holes in a stainless steel cylinder of 4300 mm. Three rotating brushes were used. The distance between the two supporting rollers (φ200 nm) positioned under the brushes was 300 mm. The brush roller was pressed against the aluminum plate until the loading of a driving motor for rotating the brush was increased by 7 kW plus relative to the degree of loading before the brush roller was pressed against the aluminum plate. The direction of rotation of the brush was the same as the direction of movement of the aluminum plate. The speed of revolutions of the brush was 200 rpm.

(b) Alkali Etching Treatment

The aluminum plate obtained in the manner described above was subjected to etching treatment by spraying with an aqueous solution of sodium hydroxide in a concentration of 2.6% by mass and aluminum ions in a concentration of 6.5% by mass at a temperature of 70° C., whereby the aluminum plate was dissolved in an amount of 10 g/m². Thereafter, the aluminum plate was washed by spraying with water.

(c) Desmut Treatment

The aluminum plate was subjected to desmut treatment with an aqueous solution (containing 0.5% by mass aluminum ions) of 1% by mass nitric acid at a temperature of 30° C. and then washed by spraying with water. The aqueous solution of nitric acid used in the desmut treatment was residual liquid produced during the step of electrochemical surface roughening treatment with an alternating current in an aqueous solution of nitric acid.

(d) Electrochemical Surface Roughening Treatment

The plate was subjected continuously to electrochemical surface roughening treatment with an alternating voltage of 60 Hz. The electrolyte used was a 10.5 g/L aqueous nitric acid solution (containing 5 g/L aluminum ions and 0.007% by mass ammonium ions) at a temperature of 50° C. The electrochemical surface roughening treatment was carried out with a carbon electrode as a counter electrode wherein, in the alternating current power source waveform, the time required for the electric current to rise from 0 to a peak was 0.8 msec., the duty ratio was 1:1 and a trapezoid rectangular wave alternating current was used. Ferrite was used as an assistant anode.

The current density was 30 A/dm² in terms of the electric current peak, and the quantity of electricity was 220 C/dm² relative to the total quantity of electricity required for anodizing the aluminum plate. 5% of the electric current from the power source was fed to the assistant anode. Thereafter, the plate was washed by spraying with water.

(e) Alkali Etching Treatment

The aluminum plate was subjected to etching treatment by spraying with an aqueous solution of sodium hydroxide in a concentration of 26% by mass and aluminum ions in a concentration of 6.5% by mass at a temperature of 32° C., whereby the aluminum plate was dissolved in an amount of 0.50 g/m². Components of smut caused by aluminum hydroxide, formed during the electrochemical surface roughening treatment using an alternating current during the previous stage, were removed. The edge of the pit formed was dissolved to smooth the edge. Thereafter, washing was carried out by spraying with water.

(f) Desmut Treatment

The aluminum plate was subjected to desmut treatment with an aqueous solution (containing 4.5% by mass aluminum ions) of 15% by mass nitric acid at a temperature of 30° C. and then washed by spraying with water. The aqueous solution of nitric acid used in the desmut treatment was residual liquid produced during the step of electrochemical surface roughening treatment with an alternating current in an aqueous solution of nitric acid.

(g) Electrochemical Surface Roughening Treatment

The plate was subjected continuously to electrochemical surface roughening treatment with an alternating voltage of 60 Hz. The electrolyte used was a 5.0 g/L aqueous hydrochloric acid solution (containing 5 g/L aluminum ions) at a temperature of 35° C. The electrochemical surface roughening treatment was carried out with a carbon electrode as a counter electrode wherein in the alternating current power source waveform, the time required for the electric current to rise from 0 to a peak was 0.8 msec., the duty ratio was 1:1 and a trapezoid rectangular wave alternating current was used. Ferrite was used as an assistant anode.

The current density was 25 A/dm² in terms of the electric current peak, and the quantity of electricity was 50 C/dm² relative to the total quantity of electricity required for anodizing the aluminum plate. Thereafter, the plate was washed by spraying with water.

(h) Alkali Etching Treatment

The aluminum plate was subjected to etching treatment by spraying with an aqueous solution of sodium hydroxide in a concentration of 26% by mass and aluminum ions in a concentration of 6.5% by mass at a temperature of 32° C., whereby the aluminum plate was dissolved in an amount of 0.10 g/m². Components of smut, caused during the previous stage by aluminum hydroxide formed during the electrochemical surface roughening treatment using the alternating current, were removed. The edge of the pit was formed dissolved to smooth the edge. Thereafter, washing was carried out by spraying with water.

(i) Desmut Treatment

The aluminum plate was subjected to desmut treatment with an aqueous solution (containing 0.5% by mass aluminum ions) of 25% by mass sulfuric acid at a temperature of 60° C. and then washed by spraying with water.

(j) Anodizing Treatment

Anodizing treatment was carried out with an anodizing device (first and second electrolyte zones of 6 m in length, first and second current feeding zones of 3 m in length, and first and second current feeding zones of 2.5 m in length). The electrolytes supplied to the first and second electrolytic zones were sulfuric acid. Both the electrolytes were 50 g/L sulfuric acid (containing 0.5% by mass aluminum ions) at a temperature of 20° C. Thereafter, washing was carried out by spraying with water. The final anodized coating was 2.7 g/m².

(k) Alkali Metal Silicate Treatment

The aluminum support obtained by the anodizing treatment was subjected to alkali metal silicate treatment (silicate treatment) by dipping of the aluminum support in a treatment bath of 1% by mass aqueous sodium silicate No. 3 at a temperature of 30 ° C. for 10 seconds. Thereafter, the aluminum support was washed by spraying with well water to produce a support with a surface rendered hydrophilic with silicate. After the alkali metal silicate treatment, the resulting aluminum support was coated with an undercoat solution having the following composition and then dried at 80 ° C. for 15 seconds, to form a coating thereon. The amount of coating after drying was 15 mg/m².

<Undercoat solution composition>

| | |
|---|---|
| The compound described below | 0.3 g |
| Methanol | 100 g |
| Water | 1 g |

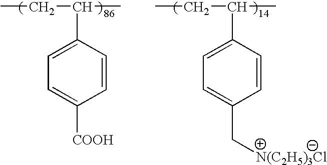

Weight average molecular weight 20,000

[Formation of a Recording Layer (Multi-Layered)]

A lower layer coating solution 1 having a composition described below was applied onto the resulting web-like substrate in an amount of 0.80 g/m² via a bar coater, dried at 160° C. for 44 seconds and immediately cooled with cooling air at 17 to 20° C. until the temperature of the substrate was reduced to 35° C.

Thereafter, an upper layer coating solution 1 with a composition described below was applied onto the upper layer in an amount of 0.26 g/m² via a bar coater, dried at 148° C. for 25 seconds and gradually cooled with air at 20 to 26° C. to prepare each of the planographic printing plate precursors in Examples 1 to 6.

<Lower Layer Coating Solution 1>

| | |
|---|---|
| Specific alkali-soluble resin described in Table 1 below | 2.133 g |
| Cyanine dye A (structure as below) | 0.124 g |
| 4,4′-Bishydroxyphenyl sulfone | 0.126 g |
| Tertrahydrophthalic anhydride | 0.190 g |
| p-Toluenesulfonic acid | 0.008 g |
| 3-Methoxy-4-diazodiphenylamine hexafluorophosphate | 0.032 g |
| Ethyl Violet with counterions | 0.0781 g |
| replaced by 6-hydroxynaphthalenesulfonic acid | |
| Polymer 1 (structure as below) | 0.035 g |
| Methyl ethyl ketone | 25.41 g |
| 1-Methoxy-2-propanol | 12.97 g |
| γ-Butryrolactone | 13.18 g |
| Cyanine dye A | |
| 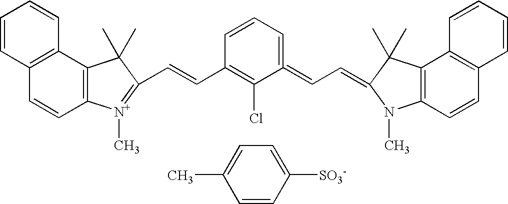 | |
| Polymer 1 | |

| | | |
|---|---|---|
| 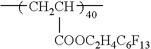 | 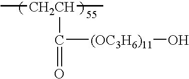 | 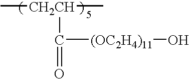 |

<Upper Layer Coating Solution 1>

| | |
|---|---|
| m, p-Cresol novolak | 0.348 g |
| (m/p ratio 6/4, | |
| weight average molecular weight 4700, | |
| containing 0.8% by mass unreacted cresol) | |
| Polymer 3 (structure as below, 30% MEK solution) | 0.1403 g |
| Cyanine dye A (structure as above) | 0.0192 g |
| Polymer 1 (structure as above) | 0.015 g |
| Polymer 2 (structure as below) | 0.00328 g |
| 1-(4-Methylbenzyl) | 0.004 g |
| 1-phenyl piperidinium 5-benzoyl-4 -hydroxy-2 - | |
| methoxybenzenesulfonate | |
| Surfactant | 0.008 g |
| (Polyoxyethylene sorbitol fatty ester, | |
| HLB 8.5, GO-4, manufactured by Nikko Chemicals Co., Ltd.) | |
| Methyl ethyl ketone | 6.79 g |
| 1-Methoxy-2-propanol | 13.07 g |
| Polymer 2 | |

| | |
|---|---|
| 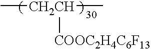 | 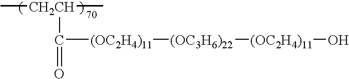 |

Polymer 3

| | |
|---|---|
| 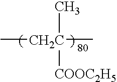 | 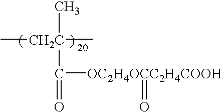 |

Weight-average molecular weight 70,000

### Comparative Example 1

The planographic printing plate precursor in Comparative Example 1 was prepared in the same manner as in Example 1 except that a lower layer coating solution 2 having the following composition not containing the specific alkali-soluble resin was used instead of the lower layer coating solution 1 used in Example 1.

<Lower layer coating solution 2>

| | |
|---|---|
| Acrylonitrile/methyl methacrylate/ | 2.133 g |
| methacrylic acid copolymer (35/45/20, | |
| weight average molecular weight 50,000, | |
| acid value 2.65 meq/g) | |
| Cyanine dye A (structure as above) | 0.124 g |
| 4,4′-Bishydroxyphenyl sulfone | 0.126 g |
| Tertrahydrophthalic anhydride | 0.190 g |
| p-Toluenesulfonic acid | 0.008 g |
| 3-Methoxy-4-diazodiphenylamine | 0.032 g |
| hexafluorophosphate | |
| Ethyl Violet with counterions | 0.0781 g |
| replaced by 6-hydroxynaphthalenesulfonic acid | |
| Polymer 1 (structure as above) | 0.035 g |
| Methyl ethyl ketone | 25.41 g |
| 1-Methoxy-2-propanol | 12.97 g |
| γ-Butryrolactone | 13.18 g |

### Comparative Example 2

The planographic printing plate precursor in Comparative Example 2 was prepared in the same manner as in Example 1 except that a lower layer coating solution 3 having a composition described below, and not containing the specific alkali-soluble resin, was used instead of the lower layer coating solution 1 used in Example 1.

<Lower Layer Coating Solution 3>

| | |
|---|---|
| Resin (P-C) described below | 2.133 g |
| Cyanine dye A (structure as above) | 0.124 g |
| 4,4′-Bishydroxyphenyl sulfone | 0.126 g |
| Tertrahydrophthalic anhydride | 0.190 g |
| p-Toluenesulfonic acid | 0.008 g |
| 3-Methoxy-4-diazodiphenylamine hexafluorophosphate | 0.032 g |
| Ethyl Violet with counterions replaced | 0.0781 g |
| by 6-hydroxynaphthalenesulfonic acid | |
| Polymer 1 (structure as above) | 0.035 g |
| Methyl ethyl ketone | 25.41 g |
| 1-Methoxy-2-propanol | 12.97 g |
| γ-Butryrolactone | 13.18 g |
| (P-C) | |
| 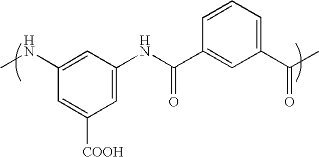 | |
| Logarithmic viscosity 0.48 dl/g | |

[Evaluation of the Planographic Printing Plate Precursor]
(Evaluation of Printing Durability)

Each of the planographic printing plate precursors in Examples 1 to 6 and Comparative Examples 1 and 2 was given exposure light energy with Trendsetter-3244VX (trade name, manufactured by CREO Co., Ltd.) to draw an image-like test pattern thereon. Thereafter, the planographic printing plate precursor was developed at a development temperature of 30° C. for a time of 12 seconds with PS Processor LP940H (trade name, manufactured by Fuji Photo Film Co., Ltd.) charged with a developer DT-2 (diluted to an electrical conductivity of 43 mS/cm) manufactured by Fuji Photo Film Co., Ltd. The printing plate was printed continuously with a printing machine Lithron manufactured by Komori Corporation. In order to evaluate printing durability, the naked eyes was used to evaluate the number of prints which can be printed with ink kept at a sufficient density. The higher the number of such prints printing plate produces is regarded as an indication of superiority in terms of printing durability. The results are shown in Table 1.

(Evaluation of Chemical Resistance)

Each of the planographic printing plate precursors in Examples 1 to 6 and the planographic printing plate precursors in Comparative Examples 1 and 2 were exposed to light, developed and used in printing in the same manner as in the evaluation of printing durability described above. After the printing of every 5,000 prints, the surface of each printing plate was wiped with a cleaner (trade name: Multi-cleaner, manufactured by Fuji Photo Film Co., Ltd.) to evaluate chemical resistance. The higher the number of complete prints produced by the printing plate is regarded as an indication of superiority in terms of chemical resistance. The results are shown in Table 1.

(Evaluation of Inking Property)

After printing of 50,000 prints in the evaluation of chemical resistance described above, the printing plate was cleaned, water was wiped off, and printing was again initiated. After initiation of printing, ink was fed to an image region, and inking property was evaluated in terms of the number of prints required before a first stable print was obtained. The results are shown in Table 1.

TABLE 1

| | | Printing durability | Chemical resistance | Number of prints |
|---|---|---|---|---|
| | | Number of | Number of complete | required before |
| | Specific alkali- | complete prints | prints | producing a first |
| | soluble resin | Units of 10,000 | Units of 10,000 | stably inked print |
| Example 1 | P-1 | 170,000 | 160,000 | 10 |
| Example 2 | P-6 | 150,000 | 140,000 | 15 |
| Example 3 | P-9 | 160,000 | 160,000 | 10 |
| Example 4 | P-14 | 180,000 | 175,000 | 10 |
| Example 5 | P-15 | 200,000 | 190,000 | 10 |
| Example 6 | P-17 | 190,000 | 185,000 | 10 |
| Comparative | — | 110,000 | 85,000 | 30 |
| Example 1 | | | | |
| Comparative | P-C | 140,000 | 130,000 | 50 |
| Example 2 | | | | |

From the results in Table 1, it can be appreciated that the planographic printing plate precursors in Examples 1 to 6 where specific alkali-soluble resin (A) was used as the characteristic component of the invention were superior, in terms of printing durability, chemical resistance and inking property, to the planographic printing plate precursors in used in Comparative Examples 1 and 2 wherein specific alkali-soluble resin (A) was not used.

### Examples 7 to 10

[Preparation of a Support]

The surface of an aluminum plate (material: JIS A1050) of 0.30 mm in thickness was subjected to etching treatment with caustic soda in a concentration of 30 g/l and aluminum ions in a concentration of 10 g/l at a solution temperature of 60° C. for 10 seconds, then washed with running water, neutralized with 10 g/l nitric acid and washed with water. The support was subjected to electrochemical surface roughening treatment with a sine-wave electric current of 500 C/dm² in an alternating waveform at an applied voltage (Va) of 20 V in an aqueous solution containing hydrogen chloride in a concentration of 15 g/l and aluminum ions in a concentration of 10 g/l at a solution temperature of 30° C. After washing with water, the support was subjected to etching treatment with caustic soda in a concentration of 30 g/l and aluminum ions in a concentration of 10 g/l at a solution temperature of 40° C. for 10 seconds and then washed with running water.

Then, the support was subjected to desmut treatment in an aqueous sulfuric acid solution containing sulfuric acid in a concentration of 15% by mass at a solution temperature of 30° C. and then washed with water. The support was then subjected to anodizing treatment at a direct current of 6 A/dm² in 10% by mass aqueous sulfuric acid solution at a solution temperature of 20° C. to form a 2.5 g/m² anodized film thereon, then washed with water and dried.

Thereafter, the support was treated with 2.5% by mass aqueous sodium silicate solution at 30° C. for 10 seconds to prepare a substrate. The central line surface roughness (Ra) of the substrate, as determined by a needle of 2 μm in thickness, was 0.48 μm. The aluminum substrate thus obtained after silicate treatment was coated with an undercoat solution having a composition described below and dried at 80° C. for 15 seconds to form a coating thereon. The amount of coating after drying was 17 mg/m².

<Undercoat solution composition>

| | |
|---|---|
| Compound as below | 0.3 g |
| Methanol | 100 g |
| Water | 1 g |

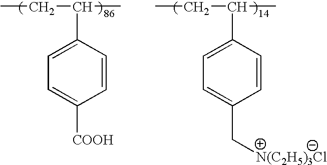

Weight average molecular weight 20,000

[Formation of a Recording Layer (Single Layer)]

A new recording layer was formed by applying onto the substrate obtained in the manner described above, and then drying, a recording layer (single layer) coating solution 1 having a composition described bwloq in an amount so as to become 1.6 g/m² after drying. In this manner, the planographic printing plate precursors in Examples 7 to 10 were obtained.

<Recording layer (single layer) coating solution 1>

| | |
|---|---|
| Novolak resin | 0.5 g |
| (m/p-cresol (6/4), | |
| weight average molecular weight 7000, | |
| 0.5% by mass unreacted cresol) | |
| Specific alkali-soluble resin shown in Table 2 | 1.0 g |
| Cyanine dye A (structure as above) | 0.1 g |
| Tertrahydrophthalic anhydride | 0.05 g |
| p-Toluenesulfonic acid | 0.002 g |
| Ethyl Violet with counterions replaced by | 0.02 g |
| 6-hydroxy-β-naphthalenesulfonic acid | |
| Fluorine-type polymer | 0.015 g |
| (trade name: MEGAFACE F-176 (solids content 20%), | |
| manufactured by Dainippon Ink and Chemicals, Inc.) | |
| Fluorine-type polymer | 0.035 g |
| (trade name: MEGAFACE MCF-312 (solids content 30%), | |
| manufactured by Dainippon Ink and Chemicals, Inc.) | |
| Lauryl stearate | 0.03 g |
| γ-Butryrolactone | 8.5 g |
| 1-Methoxy-2-propanol | 3.5 g |

### Comparative Example 3

[Formation of a Recording Layer]

A recording layer (single layer) coating solution 2 having a composition described below was applied on the same undercoated support as in Example 7 and dried in a amount so as to become 1.6 g/m² on a dry weight basis, and a recording layer thus formed. The planographic printing plate precursor in Comparative Example 3 was thereby obtained.

<Recording layer (single layer) coating solution 2>

| | |
|---|---|
| Novolak resin | 0.5 g |
| (m/p-cresol (6/4), weight average molecular | |
| weight 7000, 0.5% by mass unreacted cresol) | |
| Acrylonitrile/ethyl acrylate/methacrylic acid copolymer | 1.0 g |
| (35/55/10, weight average molecular | |
| weight 50,000, acid value 2.65 meq/g) | |
| Cyanine dye A (structure as above) | 0.1 g |
| Tertrahydrophthalic anhydride | 0.05 g |
| p-Toluenesulfonic acid | 0.002 g |
| Ethyl Violet with counterions replaced by | 0.02 g |
| 6-hydroxy-β-naphthalenesulfonic acid | |
| Fluorine-type polymer | 0.015 g |
| (trade name: MEGAFACE F-176 | |
| (solids content 20%), manufactured by | |
| Dainippon Ink and Chemicals, Inc.) | |
| Fluorine-type polymer | 0.035 g |
| (trade name: MEGAFACE MCF-312 (solids content 30%), | |
| manufactured by Dainippon Ink and Chemicals, Inc.) | |
| Lauryl stearate | 0.03 g |
| γ-Butryrolactone | 8.5 g |
| 1-Methoxy-2-propanol | 3.5 g |

[Evaluation of the Planographic Printing Plate Precursors (Printing Durability, Chemical Resistance, Inking Property)]

The planographic printing plate precursors in Examples 7 to 10 and Comparative Example 3 were also exposed to light, developed and used in printing in the same manner as in Example 1. Printing durability, chemical resistance and inking property were also evaluated in the same manner as above. The results are shown in Table 2.

TABLE 2

| | | | Chemical resistance | |
|---|---|---|---|---|
| | | Printing durability | Number of complete | Number of prints |
| | | Number of | prints | required before a |
| | Specific alkali- | complete prints | Units of ten | first stably inked |
| | soluble resin | Units of 10,000 | thousand | print was produced |
| Example 7 | P-2 | 170,000 | 170,000 | 10 |
| Example 8 | P-5 | 160,000 | 155,000 | 10 |
| Example 9 | P-8 | 190,000 | 185,000 | 15 |
| Example 10 | P-15 | 180,000 | 175,000 | 10 |
| Comparative | — | 80,000 | 85,000 | 70 |
| Example 3 | | | | |

From the results in Table 2, it is evident that the planographic printing plate precursors in Examples 7 to 10, where the specific alkali-soluble resin (A) was used as the characteristic component of the invention, were superior, in terms of printing durability, chemical resistance and inking property, to the planographic printing plate precursor in Comparative Example 3 wherein specific alkali-soluble resin (A) was not used.

### Example 11

The planographic printing plate precursor in Example 11 was prepared in the same way as for Example 1, by arranging the same undercoat and the same recording layer (lower and upper layers) as in Example 1, except insofar that in the preparation of the support, silicate treatment was not conducted after the anodizing treatment.

(Evaluation of Printing Durability and Chemical Resistance)

The resulting planographic printing plate precursor in Example 11 was exposed to light in the same manner as in Example 1, and developed at a development temperature of 28° C. for a period of 30 seconds with a PS Processor LP940H (trade name, manufactured by Fuji Photo Film Co., Ltd.) charged with a developer A described below. Thereafter, printing resistance and chemical resistance were evaluated in the same manner as in Example 1.

<Alkali-soluble developer A composition>

| | |
|---|---|
| SiO₂.K₂O (K₂O/SiO₂ = 1/1 (molar ratio)) | 4.0% by mass |
| Citric acid | 0.5% by mass |
| Polyethylene glycol-modified sorbitol | 1.0% by mass |
| (adduct with about 30 units added) | |
| Water | 50.0% by mass |

The results indicated that printing durability and chemical resistance were 170,000 and 165,000 respectively in terms of the number of complete prints, the same numbers of complete prints as in Example 1. It was thus confirmed that in Example 11, in which a planographic printing plate precursor using a substrate not subjected to hydrophilization treatment with a silicate was developed with a silicate developer excellent printing durability and chemical resistance were achieved in the same way as in Example 1, in which a planographic printing plate precursor using a silicate-treated substrate was developed with a non-silicate developer.

1. A planographic printing plate precursor including a recording layer capable of forming an image upon irradiation with infrared rays, wherein the recording layer comprisng:
(A) an alkali-soluble resin having, in a main chain, a structural unit containing at least one type of bond selected from an amide bond, an urea bond, an urethane bond and an ester bond, and having at least one type of acid group selected from a phenolic hydroxyl group, a sulfonamide group and an active imide group; and
(B) an infrared absorbing agent.

2. The planographic printing plate precursor according to claim 1, wherein the at least one type of bond is represented by one of formulae (1) to (4): 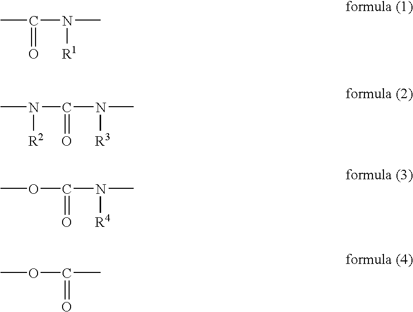
wherein R¹ to R⁴ each independently represents a hydrogen atom, an alkyl group or a carbonyl group, and when any one of R¹ to R⁴ is a carbonyl group, the any one of R¹ to R⁴ may be bonded to another functional group in the resin to form a cyclic imide structure.

3. The planographic printing plate precursor according to claim 2, wherein R¹ to R⁴ each represents a hydrogen atom.

4. The planographic printing plate precursor according to claim 2, wherein the at least one type of bond represented by one of formulae (1) to (3) is a bond containing a nitrogen atom.

5. The planographic printing plate precursor according to claim 1, wherein a content of the at least one type of bond contained in alkali-soluble resin (A) is 0.5 to 10 meq/g (equivalent (unit: mmol) of the specific bond contained per 1 g of the resin).

6. The planographic printing plate precursor according to claim 1, wherein the acid group is a phenolic hydroxyl group.

7. The planographic printing plate precursor according to claim 1, wherein the alkali-soluble resin (A) further comprises a carboxyl group.

8. The planographic printing plate precursor according to claim 1, wherein, in the alkali-soluble resin (A), a content of all alkali soluble groups, including the acid group, is 1.0 to 10 meq/g.

9. The planographic printing plate precursor according to claim 1, wherein atoms constituting the main chain of alkali-soluble resin (A) form an aromatic ring structure containing a phenylene skeleton and/or alicyclic structure.

10. The planographic printing plate precursor according to claim 1, wherein the recording layer further comprises a development inhibitor (C) which reduces alkali solubility of alkali-soluble resin (A) but which, upon irradiation with infrared rays, loses its ability to reduce alkali solubility.

11. A planographic printing plate precursor including a recording layer, wherein the recording layer comprising:
(A) an alkali-soluble resin having, in a main chain, a structural unit containing at least one type of bond selected from an amide bond, urea bond and an urethane bond, and having at least one type of acid group selected from a phenolic hydroxyl group, a sulfonamide group and an active imide group; and
(B) an infrared absorbing agent,
wherein atoms constituting the main chain of alkali-soluble resin (A) form an aromatic ring structure containing a phenylene skeleton and/or an alicyclic structure.

12. A planographic printing plate precursor according to claim 11, wherein the at least one type of bond is represented by one of formulae (1) to (3) blow: 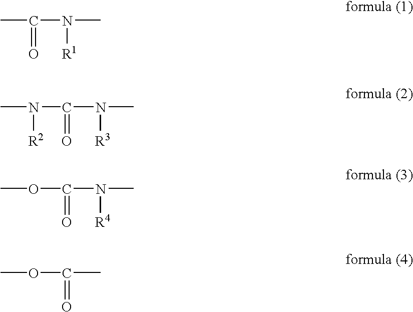
wherein R¹ to R⁴ each independently represents a hydrogen atom, an alkyl group or a carbonyl group, and when any one of R¹ to R⁴ is a carbonyl group, the any one of R¹ to R⁴ may be bonded to another functional group in the resin to form a cyclic imide structure.

13. The planographic printing plate precursor according to claim 12, wherein the acid group is a phenolic hydroxyl group.

14. The planographic printing plate precursor according to claim 12, wherein the alkali-soluble resin (A) further comprises a carboxyl group.

15. The planographic printing plate precursor according to claim 11, wherein the recording layer further comprises a development inhibitor (C) which reduces alkali solubility of alkali-soluble resin (A) but which, upon irradiation with infrared rays, loses an ability to reduce alkali solubility.

16. A planographic printing plate precursor having a recording layer, wherein the recording layer comprising:
a lower layer containing a first alkali-soluble resin; and
an upper layer containing a second alkali-soluble resin, and a substance acting on the second alkali-soluble resin to reduce alkali solubility thereof,
wherein the first alkali-soluble resin has, in a main chain, a structural unit containing at least one type of bond selected from an amide bond, an urea bond and an urethane bond, and simultaneously has at least one type of acid group selected from a phenolic hydroxyl group, a sulfonamide group and an active imide group, and wherein the substance reducing the alkali solubility of the second alkali-soluble resin, upon irradiation with infrared rays, loses an ability to reduce alkali solubility of the second alkali-soluble resin.

17. The planographic printing plate precursor according to claim 16, wherein at least one of the upper layer and the lower layer includes an infrared absorbing agent.

18. The planographic printing plate precursor according to claim 16, wherein the at least one type of bond is represented by one of formulae (1) to (4) below: 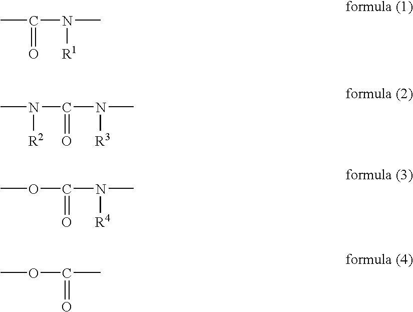
wherein R¹ to R⁴ each independently represents a hydrogen atom, an alkyl group or a carbonyl group, and when any one of R¹ to R⁴ is a carbonyl group, the any one of R¹ to R⁴ may be bonded to another functional group in the resin to form a cyclic imide structure.

19. The planographic printing plate precursor according to claim 18, wherein the acid group is a phenolic hydroxyl group.

20. The planographic printing plate precursor according to claim 18, wherein the alkali-soluble resin (A) further comprises a carboxyl group.
